(19) United States
(12) Patent Application Publication
(10) Pub. No.: US 2022/0123336 A1
(43) Pub. Date: Apr. 21, 2022

(54) ELECTRIC POWER SUPPLY SYSTEM, AND CONTROL DEVICE AND CONTROL METHOD FOR ELECTRIC POWER SUPPLY SYSTEM

(71) Applicant: Panasonic Intellectual Property Management Co.,Ltd., Osaka (JP)

(72) Inventors: Tomoki ITO, Hyogo (JP); Yasufumi TAKAHASHI, Osaka (JP); Atsushi SHIMIZU, Osaka (JP)

(21) Appl. No.: 17/429,460

(22) PCT Filed: Feb. 10, 2020
(86) PCT No.: PCT/JP2020/005173

§ 371 Date: Aug. 9, 2021

(30) Foreign Application Priority Data
Feb. 12, 2019 (JP) 2019-022710
Feb. 12, 2019 (JP) 2019-022721

(51) Int. Cl. H01M 8/04858; H02J 7/00; H01M 8/0606; H01M 8/04082

(52) U.S. Cl. CPC H01M 8/04925; H02J 7/0068; B60L 50/70; H01M 8/04201; H01M 8/0606

(57) ABSTRACT

An electric power supply system includes: a hydrogen production device producing hydrogen using electric power supplied from a natural-energy power generator; a hydrogen storage device storing the produced hydrogen; a fuel cell system generating electricity using the stored hydrogen to supply the generated electric power to a load; an electric power accumulator accumulating electric power supplied from the natural-energy power generator, to supply the accumulated power to the load; and a control device controls supply of electric power from the fuel cell system and the electric power accumulator to the load. The control device executes a first control for supplying electric power to the load from each of the electric power accumulator and the fuel cell system in a time zone in which demanded power of the load is smaller than electric power dischargeable from the electric power accumulator.

### TECHNICAL FIELD

The present disclosure relates to an electric power supply system supplying electric power to a load from an electric power line, a natural-energy power generator, and an energy storage system accumulating surplus electric power of the natural-energy power generator for supply, and to a control device and a control method for the electric power supply system.

### BACKGROUND ART

The conventional electric power supply system is, for example, one (see, e.g., Patent Document 1) determining the amount of electric power supplied to an electric power accumulator during the daytime and the amount of electric power supplied to a hydrogen production device during the daytime, based on predicted values of the generated power amount of the natural-energy power generator and on predicted values of the demanded power amount of the load side. Such a system further determines, based on the above predicted values, the amount of electric power supplied from the electric power accumulator to the load during the nighttime and the amount of electric power supplied from a fuel cell system to the load during the nighttime.

### PATENT DOCUMENT

Patent Document 1: JP-618944882

### SUMMARY OF THE INVENTION

When operated in liaison with the electric power line, the conventional electric power supply system can achieve reduction in the capacity and cost of equipment since electric power can be purchased from the line even if no electric power can be supplied to the load from the natural-energy power generator, the electric power accumulator, and the fuel cell system. In this case, however, the equipment capacity imposes limitation on electric power chargeable into/dischargeable from the electric power accumulator per unit time and on electric power generable by the fuel cell system. For this reason, when storing energy generated by the natural-energy power generator to supply electric power to the load in a time zone in which the natural-energy power generator does not generate electricity, there may occur a need to purchase electric power unnecessarily. That is, even though the stored energy is enough for the load, a part of the electric power may not be supplied to the load due to limitation on electric power capable of being output per unit time, with the result that electric power is purchased from outside of the system.

When storing surplus electric power of electric power generated by the natural-energy power generator, the surplus electric power may be released as electricity selling to outside of the system since the surplus electric power cannot be stored. That is, even though the accumulable capacity is enough for the surplus electric power, a part of electric power may not be accumulated due to limitation on electric power capable of being input per unit time, with the result that electric power is released to outside of the system.

The present disclosure solves the above conventional problem and an object thereof is to provide an electric power supply system capable of accumulating electric power generated by the natural-energy power generator and improving the use efficiency of the accumulated power in a time zone in which the natural-energy power generator does not generate electricity, and a control device and a control method for the electric power supply system.

It is also an object of the present disclosure to provide an electric power supply system capable of improving the accumulation efficiency for surplus electric power of the natural-energy power generator, and a control device and a control method for the electric power supply system.

In order to achieve the object, the electric power supply system, and the control device and control method for the electric power supply system of the present disclosure are configured as follows.

An electric power supply system according to one aspect of the present disclosure includes: a hydrogen production device producing hydrogen using electric power supplied from a natural-energy power generator; a hydrogen storage device storing hydrogen produced by the hydrogen production device; a fuel cell system generating electricity using hydrogen stored in the hydrogen storage device, to supply the generated electric power to a load; an electric power accumulator accumulating electric power supplied from the natural-energy power generator, to supply the accumulated power to the load; and a control device configured to control supply of electric power from the fuel cell system and the electric power accumulator to the load. The control device executes a first control for supplying electric power to the load from each of the electric power accumulator and the fuel cell system in a time zone in which demanded power of the load is smaller than electric power dischargeable from the electric power accumulator.

A method of controlling an electric power supply system according to one aspect of the present disclosure, the electric power supply system supplying electric power to a load from an electric power line, a natural-energy power generator, an electric power accumulator, and a fuel cell system, the method includes: producing hydrogen by a hydrogen production device using surplus electric power of the natural-energy power generator; storing the produced hydrogen in a hydrogen storage device; generating electricity by the fuel cell system using the stored hydrogen, to supply electric power to the load; charging the electric power accumulator with surplus electric power of the natural-energy power generator; discharging electricity from the electric power accumulator, to supply electric power to the load; and executing a first control for supplying electric power to the load from each of the electric power accumulator and the fuel cell system in a time zone in which demanded power of the load is smaller than electric power dischargeable from the electric power accumulator.

A control device of an electric power supply system according to one aspect of the present disclosure, the electric power supply system supplying electric power to a load from an electric power line, a natural-energy power generator, an electric power accumulator charged with surplus electric power of the natural-energy power generator, and a fuel cell system generating electricity using hydrogen generated with surplus electric power of the natural-energy power generator, the control device includes: a power distribution ratio control unit configured to set a power distribution ratio of electric power so that electric power is supplied to the load from each of the electric power accumulator and the fuel cell system in a time zone in which demanded power of the load is smaller than electric power dischargeable from the electric power accumulator; and an equipment control unit configured to provide control to supply electric power from the electric power accumulator and the fuel cell system to the load, based on the power distribution ratio set by the power distribution ratio control unit.

An electric power supply system according to one aspect of the present disclosure includes: a hydrogen production device producing hydrogen using electric power supplied from a natural-energy power generator; a hydrogen storage device storing hydrogen produced by the hydrogen production device; a fuel cell system generating electricity using hydrogen stored in the hydrogen storage device, to supply the generated electric power to a load; an electric power accumulator accumulating electric power supplied from the natural-energy power generator, to supply the accumulated power to the load; and a control device configured to control supply of surplus electric power of the natural-energy power generator to the fuel cell system and the electric power accumulator. The control device executes a first control for supplying the surplus electric power to each of the electric power accumulator and the hydrogen production device in a time zone in which the surplus electric power of the natural-energy power generator is smaller than electric power chargeable into the electric power accumulator.

A method of controlling an electric power supply system according to one aspect of the present disclosure, the electric power supply system supplying surplus electric power of a natural-energy power generator to an electric power accumulator, a hydrogen production device, and an electric power line, the method includes: producing hydrogen by the hydrogen production device using the surplus electric power of the natural-energy power generator; storing the produced hydrogen in a hydrogen storage device; generating electricity by a fuel cell system using the stored hydrogen, to supply electric power to a load; charging the electric power accumulator with surplus electric power of the natural-energy power generator; discharging electricity from the electric power accumulator, to supply electric power to the load; and executing a first control for supplying the surplus electric power of the natural-energy power generator to each of the electric power accumulator and the hydrogen production device in a time zone in which the surplus electric power is smaller than electric power chargeable into the electric power accumulator.

A control device of an electric power supply system according to one aspect of the present disclosure, the electric power supply system including an electric power line, a natural-energy power generator, an electric power accumulator accumulating surplus electric power of the natural-energy power generator to supply the accumulated power to a load, a hydrogen production device producing hydrogen using the surplus electric power of the natural-energy power generator, a hydrogen storage device storing therein hydrogen produced by the hydrogen production device, and a fuel cell system generating electricity using hydrogen stored in the hydrogen storage device to supply the generated electric power to the load, the control device includes: a power supply ratio control unit configured to set a power supply ratio of the surplus electric power of the natural-energy power generator so that the surplus electric power is supplied to each of the electric power accumulator and the hydrogen production device in a time zone in which the surplus electric power is smaller than electric power chargeable into the electric power accumulator; and an equipment control unit configured to provide control to supply the surplus electric power of the natural-energy power generator to the electric power accumulator and the hydrogen production device, based on the power supply ratio set by the power supply ratio control unit.

According to the electric power supply system and its control device and control method of the present disclosure, it is possible to accumulate electric power generated by the natural-energy power generator and improve the use efficiency of the accumulated power in a time zone in which the natural-energy power generator does not generate electricity.

According to the electric power supply system and its control device and control method of the present disclosure, it is possible to improve the accumulation efficiency for surplus electric power of the natural-energy power generator.

### BRIEF DESCRIPTION OF DRAWINGS

FIG. 1 is a view showing an example of an electric power supply system according to a first embodiment of the present disclosure.

FIG. 2 is a view showing an example of a configuration of a control device included in the electric power supply system of the first embodiment.

FIG. 3A is a surplus electric power model in accumulated energy control according to comparative example 1.

FIG. 3B is a surplus electric power model in accumulated energy control according to comparative example 2.

FIG. 4 is a flowchart of accumulated energy control of the first embodiment.

FIG. 5A is a surplus electric power model in accumulated energy control according to example 1 of the first embodiment.

FIG. 5B is a surplus electric power model in accumulated energy control according to example 1 of the first embodiment.

FIG. 6A is a demanded power model in released energy control according to comparative example 3.

FIG. 6B is a demanded power model in released energy control according to comparative example 4.

FIG. 7 is a flowchart of released energy control of the first embodiment.

FIG. 8A is a demanded power model in released energy control according to Example 1 of the first embodiment.

FIG. 8B is a demanded power model in the released energy control according to Example 1 of the first embodiment.

FIG. 9 is a flowchart of accumulated energy control of a second embodiment.

FIG. 10A is a surplus electric power model (k=1) in accumulated energy control according to Example 2 of the second embodiment.

FIG. 10B is a surplus electric power model (k=2) in the accumulated energy control according to example 2 of the second embodiment.

FIG. 10C is a surplus electric power model (k=3) in the accumulated energy control according to example 2 of the second embodiment.

FIG. 11 is a flowchart of released energy control of the second embodiment.

FIG. 12A is a demanded power model (k=1) in released energy control according to example 2 of the second embodiment.

FIG. 12B is a demanded power model (k=2) in the released energy control according to example 2 of the second embodiment.

FIG. 12C is a demanded power model (k=3) in the released energy control according to Example 2 of the second embodiment.

FIG. 13 is a flowchart of accumulated energy control of examples 3 and 4 of other embodiments.

FIG. 14 is a surplus electric power model in the accumulated energy control according to example 3.

FIG. 15 is a surplus electric power model in the accumulated energy control according to example 4.

FIG. 16 is a flowchart of released energy control of examples 3 and 4 of the other embodiments.

FIG. 17 is a demanded power model in the released energy control according to example 3.

FIG. 18 is a demanded power model in the released energy control according to example 4.

### EMBODIMENT(S) FOR CARRYING OUT THE INVENTION

### Findings of the Disclosure

The inventors diligently studied to solve the above problem. As a result, the following findings were obtained.

The present disclosure relates to control in an energy network supplying electric power to a load from an electric power line, a natural-energy power generator, and an electric power supply system accumulating surplus electric power of the natural-energy power generator for supply. The electric power supply system includes: a storage system (storage and supply system) accumulating electric power or electric-power-based energy and supplying the accumulated energy as electric power; and a control device. The storage system includes: a hydrogen production device producing hydrogen with electric power; a hydrogen storage device storing hydrogen produced by the hydrogen production device; a fuel cell system generating electricity using hydrogen stored in the hydrogen storage device; and an electric power accumulator accumulating electric power in a suppliable manner.

In this electric power supply system, hereinafter, the hydrogen production device, the hydrogen storage device, and the fuel cell system are referred to as “hydrogen-type power storage device” for convenience's sake. The hydrogen production device being supplied with electric power is referred to for convenience's sake as “hydrogen-type power storage device” being charged with electricity. Electric power being output from the fuel cell system is referred to for convenience's sake as electricity being discharged from “hydrogen-type power storage device”. Input electric power (consumed electric power) of the hydrogen production device is referred to for convenience's sake as charged electric power of “hydrogen-type power storage device”, while the generated electric power of the fuel cell system is referred to for convenience's sake as discharged electric power of “hydrogen-type power storage device”. The total generated power amount when assumed that the fuel cell system generates electricity using all of hydrogen stored in the hydrogen storage device is referred to for convenience's sake as stored power amount.

In the case where this electric power supply system (energy network) is in liaison with the electric power line, the energy network flowing back (supplying) electric power to the electric power line and the energy network receiving electric power are referred to respectively as “electricity selling” and “electricity buying”.

In the present disclosure, “surplus electric power of natural-energy power generator” means a difference of the generated power of the natural-energy power generator relative to the demanded power (consumed power of the load). When the surplus electric power takes a positive value, it is meant that the demanded power is smaller than the generated power of the natural-energy power generator, whereas when the surplus electric power takes a negative value, it is meant that the demanded power is larger than the generated power of the natural-energy power generator.

By the way, the ability of the storage system to store electric power is limited by the electric power (e.g. rated power) chargeable or dischargeable per unit time of the storage system and by the storable power amount (capacity) of the storage system.

Comparing the electric power accumulator and the hydrogen-type power storage device making up the storage system with each other, the electric power accumulator is larger than the hydrogen-type power storage device in electric power chargeable or dischargeable per unit time but is smaller in storable power amount.

Taking the energy efficiency into consideration, it is appropriate to perform charge or discharge of the electric power accumulator with higher priority than the hydrogen-type power storage device.

However, priority use of the electric power accumulator in the case of positive surplus electric power allows the remaining accumulated power amount of the electric power accumulator to reach its upper limit earlier, whereupon only the hydrogen-type power storage device with small chargeable power per unit time can accumulate surplus electric power (hydrogen). For this reason, unaccumulable surplus electric power undergoes electricity selling. This power amount for the electricity selling is eventually the power amount incapable of being stored in the storage system. This power amount for electricity selling leads to electricity buying when the surplus electric power is negative.

On the contrary, priority use of the electric power accumulator in the case of negative surplus electric power allows the remaining accumulated power amount of the electric power accumulator to reach its lower limit earlier, whereupon only the hydrogen-type power storage device with small dischargeable power per unit time can release electricity. For this reason, the shortfall of electric power relative to the demanded power needs to be purchased.

That is, if charge of discharge of the electric power accumulator is executed preferentially irrespective of the positive or negative of surplus electric power, the surplus electric power of the natural-energy power generator cannot be accumulated with high efficiency and the accumulated energy cannot be used efficiently, resulting in easy occurrence of electricity buying. If the electricity rate of the electricity buying is higher than that of the electricity selling, the occurrence of electricity buying results in high electricity usage fee.

The inventors of the present disclosure made diligent studies and reached findings that in order to prevent electricity buying from occurring, the electric power accumulator and the hydrogen-type power storage device may be used without giving priority to the electric power accumulator so that the remaining accumulated power amount of the electric power accumulator cannot arrive earlier at its upper limit or lower limit.

The time for the remaining accumulated power amount of the electric power accumulator to reach its upper limit or lower limit can be adjusted by adjusting the ratio between the charged power of the electric power accumulator and the charged power of the hydrogen-type power storage device in the case of the positive surplus electric power or by adjusting the ratio between the discharged power of the electric power accumulator and the discharged power of the hydrogen-type power storage device in the case of the negative surplus electric power.

The amount of electricity buying and therefore the electricity usage fee can be adjusted by adjusting the ratio between the charged power of the electric power accumulator and the charged power of the hydrogen-type power storage device in the case of the positive surplus electric power or by adjusting the ratio between the discharged power of the electric power accumulator and the discharged power of the hydrogen-type power storage device in the case of the negative surplus electric power.

The present disclosure was made on the basis of such findings.

### Contents of the Disclosure

An electric power supply system according to the first aspect of the present disclosure includes: a hydrogen production device producing hydrogen using electric power supplied from a natural-energy power generator; a hydrogen storage device storing hydrogen produced by the hydrogen production device; a fuel cell system generating electricity using hydrogen stored in the hydrogen storage device, to supply the generated electric power to a load; an electric power accumulator accumulating electric power supplied from the natural-energy power generator, to supply the accumulated power to the load; and a control device configured to control supply of electric power from the fuel cell system and the electric power accumulator to the load, wherein the control device executes a first control for supplying electric power to the load from each of the electric power accumulator and the fuel cell system in a time zone in which demanded power of the load is smaller than electric power dischargeable from the electric power accumulator.

The electric power supply system according to the second aspect of the present disclosure, in the first aspect, wherein the control device may execute a second control for rendering electric power supplied from the electric power accumulator to the load smaller than electric power dischargeable from the electric power accumulator in a time zone in which demanded power of the load is larger than electric power dischargeable from the electric power accumulator.

The electric power supply system according to the third aspect of the present disclosure, in the first or second aspect, wherein the control device may execute the first control when demanded power amount that is integrated demanded power value of the load in a predetermined period of time is larger than power amount dischargeable from the electric power accumulator.

The electric power supply system according to the fourth aspect of the present disclosure, in the second aspect, wherein the control device may execute the first control and the second control when demanded power amount that is integrated value of demanded power of the load in a predetermined period of time is larger than power amount dischargeable from the electric power accumulator.

A method of controlling an electric power supply system according to the fifth aspect of the present disclosure, the electric power supply system supplying electric power to a load from an electric power line, a natural-energy power generator, an electric power accumulator, and a fuel cell system, the method includes: producing hydrogen by a hydrogen production device using surplus electric power of the natural-energy power generator; storing the produced hydrogen in a hydrogen storage device; generating electricity by the fuel cell system using the stored hydrogen, to supply electric power to the load; charging the electric power accumulator with surplus electric power of the natural-energy power generator; discharging electricity from the electric power accumulator, to supply electric power to the load; and executing a first control for supplying electric power to the load from each of the electric power accumulator and the fuel cell system in a time zone in which demanded power of the load is smaller than electric power dischargeable from the electric power accumulator.

The method of controlling an electric power supply system according to the sixth aspect of the present disclosure, in the fifth aspect, may further include: executing a second control for rendering electric power supplied from the electric power accumulator to the load smaller than electric power dischargeable from the electric power accumulator in a time zone in which demanded power of the load is larger than electric power dischargeable from the electric power accumulator.

A control device of an electric power supply system according to the seventh aspect of the present disclosure, the electric power supply system supplying electric power to a load from an electric power line, a natural-energy power generator, an electric power accumulator charged with surplus electric power of the natural-energy power generator, and a fuel cell system generating electricity using hydrogen generated with surplus electric power of the natural-energy power generator, the control device includes: a power distribution ratio control unit configured to set a power distribution ratio of electric power so that electric power is supplied to the load from each of the electric power accumulator and the fuel cell system in a time zone in which demanded power of the load is smaller than electric power dischargeable from the electric power accumulator; and an equipment control unit configured to provide control to supply electric power from the electric power accumulator and the fuel cell system to the load, based on the power distribution ratio set by the power distribution ratio control unit.

The control device of an electric power supply system according to the eighth aspect of the present disclosure, in the seventh aspect, wherein the power distribution ratio control unit may set the power distribution ratio of electric power so that electric power supplied from the electric power accumulator to the load becomes smaller than electric power dischargeable from the electric power accumulator in a time zone in which demanded power of the load is larger than electric power dischargeable from the electric power accumulator.

The control device of an electric power supply system according to the ninth aspect of the present disclosure, in the seventh or eighth aspect, wherein the power distribution ratio control unit may set the power distribution ratio of electric power so that electric power is supplied from each of the electric power accumulator and the fuel cell system to the load when demanded power amount that is integrated demanded power value of the load in a predetermined period of time is larger than power amount dischargeable from the electric power accumulator.

The control device of an electric power supply system according to the tenth aspect of the present disclosure, in the eighth aspect, wherein the power distribution ratio control unit may set the power distribution ratio of electric power so that, when demanded power amount that is integrated demanded power value of the load in a predetermined period of time is larger than power amount dischargeable from the electric power accumulator, electric power is supplied from each of the electric power accumulator and the fuel cell system to the load so that electric power supplied from the electric power accumulator to the load becomes smaller than electric power dischargeable from the electric power accumulator.

An electric power supply system according to the 11th aspect of the present disclosure, includes: a hydrogen production device producing hydrogen using electric power supplied from a natural-energy power generator; a hydrogen storage device storing hydrogen produced by the hydrogen production device; a fuel cell system generating electricity using hydrogen stored in the hydrogen storage device, to supply the generated electric power to a load; an electric power accumulator accumulating electric power supplied from the natural-energy power generator, to supply the accumulated power to the load; and a control device configured to control supply of surplus electric power of the natural-energy power generator to the fuel cell system and the electric power accumulator; wherein the control device executes a first control for supplying the surplus electric power to each of the electric power accumulator and the hydrogen production device in a time zone in which the surplus electric power of the natural-energy power generator is smaller than electric power chargeable into the electric power accumulator.

The electric power supply system according to the 12th aspect of the present disclosure, in the 11th aspect, wherein the control device may execute a second control for rendering the surplus electric power supplied to the electric power accumulator smaller than electric power chargeable into the electric power accumulator in a time zone in which the surplus electric power of the natural-energy power generator is larger than electric power chargeable into the electric power accumulator.

The electric power supply system according to the 13th aspect of the present disclosure, in the 11th or 12th aspect, wherein the control device may execute the first control when surplus electric power amount that is integrated surplus electric power value of the natural-energy power generator in a predetermined period of time is larger than power amount chargeable into the electric power accumulator.

The electric power supply system according to the 14th aspect of the present disclosure, in the 12th aspect, wherein the control device may execute the first control and the second control when surplus electric power amount that is integrated surplus electric power value of the natural-energy power generator in a predetermined period of time is larger than power amount chargeable into the electric power accumulator.

A method of controlling an electric power supply system according to the 15th aspect of the present disclosure, the electric power supply system supplying surplus electric power of a natural-energy power generator to an electric power accumulator, a hydrogen production device, and an electric power line, the method includes: producing hydrogen by the hydrogen production device using the surplus electric power of the natural-energy power generator; storing the produced hydrogen in a hydrogen storage device; generating electricity by a fuel cell system using the stored hydrogen, to supply electric power to a load; charging the electric power accumulator with surplus electric power of the natural-energy power generator; discharging electricity from the electric power accumulator, to supply electric power to the load; and executing a first control for supplying the surplus electric power of the natural-energy power generator to each of the electric power accumulator and the hydrogen production device in a time zone in which the surplus electric power is smaller than electric power chargeable into the electric power accumulator.

The method of controlling an electric power supply system according to the 16th aspect of the present disclosure, in the 15th aspect, may further include: executing a second control for rendering the surplus electric power of the natural-energy power generator supplied to the electric power accumulator smaller than electric power chargeable into the electric power accumulator in a time zone in which the surplus electric power is larger than electric power chargeable into the electric power accumulator.

A control device of an electric power supply system according to the 17th aspect of the present disclosure, the electric power supply system including an electric power line, a natural-energy power generator, an electric power accumulator accumulating surplus electric power of the natural-energy power generator to supply the accumulated power to a load, a hydrogen production device producing hydrogen using the surplus electric power of the natural-energy power generator, a hydrogen storage device storing therein hydrogen produced by the hydrogen production device, and a fuel cell system generating electricity using hydrogen stored in the hydrogen storage device to supply the generated electric power to the load, the control device includes: a power supply ratio control unit configured to set a power supply ratio of the surplus electric power of the natural-energy power generator so that the surplus electric power is supplied to each of the electric power accumulator and the hydrogen production device in a time zone in which the surplus electric power is smaller than electric power chargeable into the electric power accumulator; and an equipment control unit configured to provide control to supply the surplus electric power of the natural-energy power generator to the electric power accumulator and the hydrogen production device, based on the power supply ratio set by the power supply ratio control unit.

The control device of an electric power supply system according to the 18th aspect of the present disclosure, in the 17th aspect, wherein the power supply ratio control unit may set the power supply ratio of the surplus electric power of the natural-energy power generator so that the surplus electric power supplied to the electric power accumulator becomes smaller than electric power chargeable into the electric power accumulator in a time zone in which the surplus electric power is larger than electric power chargeable into the electric power accumulator.

The control device of an electric power supply system according to the 19th aspect of the present disclosure, in the 17th or 18th aspect, wherein the power supply ratio control unit may set the power supply ratio of the surplus electric power of the natural-energy power generator so that the surplus electric power is supplied to each of the electric power accumulator and the hydrogen production device when surplus electric power amount that is integrated surplus electric power value of the natural-energy power generator in a predetermined period of time is larger than power amount chargeable into the electric power accumulator.

The control device of an electric power supply system according to the 20th aspect of the present disclosure, in the 18th aspect, wherein the control device may set the power supply ratio of the surplus electric power of the natural-energy power generator so that, when surplus electric power amount that is integrated surplus electric power value of the natural-energy power generator in a predetermined period of time is larger than power amount chargeable into the electric power accumulator, the surplus electric power is supplied to each of the electric power accumulator and the hydrogen production device so that the surplus electric power supplied to the electric power accumulator becomes smaller than electric power chargeable into the electric power accumulator.

Embodiments of the present disclosure embodying the present disclosure will hereinafter be described with reference to the drawings.

### First Embodiment

### <Configuration>

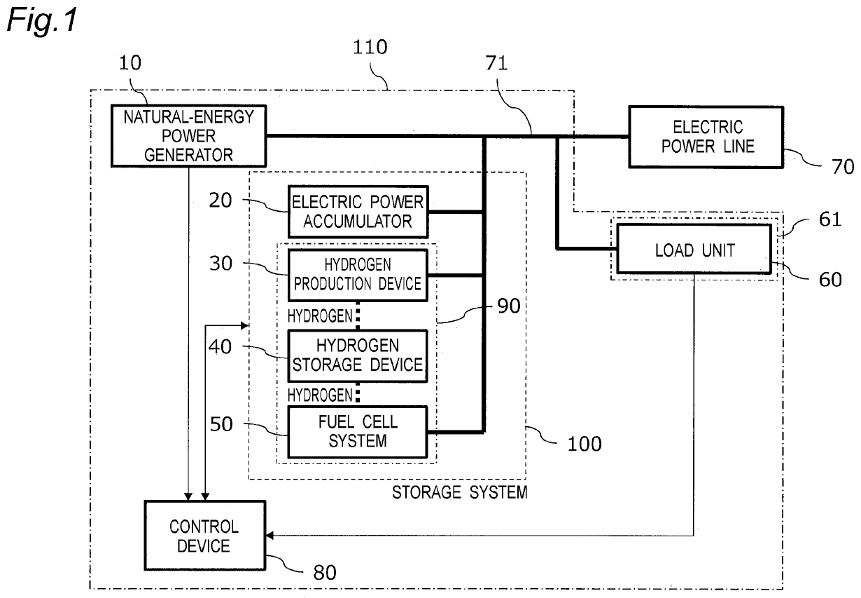

FIG. 1 is a view showing an example of an electric power supply system according to the first embodiment of the present disclosure. Referring to FIG. 1, an energy network 110 includes a natural-energy power generator 10, a storage system 100, a control device 80, and a load unit 60. In this energy network 110, the storage system 100 and the control device 80 make up the electric power supply system according to the first embodiment. The owner of the load unit 60 is a “power consumer 61 having the load unit 60”.

The storage system 100 includes an electric power accumulator 20, a hydrogen production device 30, a hydrogen storage device 40, and a fuel cell system 50. A hydrogen-type power storage device 90 includes the hydrogen production device 30, the hydrogen storage device 40, and the fuel cell system 50.

The energy network 110 is electrically connected to an electric power line 70. Specifically, the natural-energy power generator 10, the electric power accumulator 20, the hydrogen production device 30, and the fuel cell system 50 are connected via a power transmission path 71 to the load unit 60 and the electric power line 70.

The control device 80 receives, from the load unit 60, information on consumed power (demanded power) of the load unit 60 and receives, from the natural-energy power generator 10, information on generated power of the natural-energy power generator 10. The control device 80 receives, from the storage system 100, information on the power amount storage in the storage system 100. Specifically, the control device 80 receives information on the power amount storage of the electric power accumulator 20 and on the amount of hydrogen storage of the hydrogen storage device 40.

Based on these pieces of information, the control device 80 controls operations of the electric power accumulator 20, the hydrogen production device 30, and the fuel cell system 50. Specifically, the control device 80 controls electric power supplied from the natural-energy power generator 10 to the storage system 100 and electric power distributed from the storage system 100 to the load unit 60.

Although the target of application of this energy network 110 is not particularly limited, examples include remote islands, factories, commercial facilities, and houses. When the application target of the energy network 110 is a house, the owner of the house is the “power consumer 61 having the load unit 60” and is also the owner of the energy network 110.

These elements will be described in detail below.

### <Natural-Energy Power Generator>

The natural-energy power generator 10 is a device that generates electricity by utilizing natural energy. In this embodiment, the natural-energy power generator 10 is, for example, a photovoltaic power generator that utilizes sunlight to generate electricity. The natural-energy power generator 10 may be, for example, a wind power generator or a hydroelectric power generator.

### <Storage System>

The storage system 100 is connected to the natural-energy power generator 10, the electric power line 70, and the load unit 60. The storage system 100 stores, as electric energy or other forms of energy, electricity generated by the natural-energy power generator 10 or electric power received from the electric power line 70 and supplies the stored energy as electric power to the load unit 60. Power supply to the storage system 100 and power distribution from the storage system 100 are controlled by the control device 80. The storage system 100 may not be connected to the electric power line 70.

### <Electric Power Accumulator>

The electric power accumulator 20 accumulates, under control of the control device 80, electric power (electric energy) generated by the natural-energy power generator 10 or electric power received from the electric power line 70. The accumulated power is discharged (supplied) to the load unit 60 or the electric power line 70 under control of the control device 80. The electric power accumulator 20 sends to the control device 80 information on the state of charge (SOC) indicative of the remaining power amount (electric charge) stored. The electric power accumulator 20 is, for example, a secondary battery, a capacitor, or the like. The electric power accumulator 20 may not be connected to the electric power line 70.

### <Hydrogen Production Device>

The hydrogen production device 30 produces hydrogen, under control of the control device 80, by using electricity generated by the natural-energy power generator 10 or electric power received from the electric power line 70. The hydrogen production device 30 may have any configuration as long as hydrogen is produced using electric energy. For example, it may be a water electrolyzer.

### <Hydrogen Storage Device>

The hydrogen storage device 40 stores hydrogen produced by the hydrogen production device and releases stored hydrogen. The hydrogen storage device 40 may be, for example, a hydrogen-absorbing alloy high-pressure hydrogen tank or a liquefied hydrogen storage device that converts hydrogen into decalin or the like and stores it in the liquefied state. In this embodiment, the case is taken as an example where the hydrogen storage device 40 is the high-pressure hydrogen tank. The hydrogen production device 30 includes measuring equipment such as pressure gauges (not shown) and sends information on the remaining amount of hydrogen stored, to the control device 80.

### <Fuel Cell System>

Under control of the control device 80, the fuel cell system 50 utilizes hydrogen released from the hydrogen storage device 40, to generate electricity. The generated electric power is supplied to the load unit 60 or the electric power line 70. The fuel cell system 50 can be a well-known one. The fuel cell system 50 may not be connected to the electric power line 70.

### <Control Device>

The control device 80 may be any one as long as it has control functions. The control device 80 includes an arithmetic processing unit (not shown) and a storage unit storing a control program. The arithmetic processing unit reads and executes a control program stored in the storage unit so that the control device 80 provides predetermined control. Examples of the arithmetic processing unit include a microcontroller, a programmable logic controller (PLC), a microprocessor, and a field-programmable gate array (FPGA). An example of the storage unit includes a memory. In this embodiment, the control device 80 is composed of, for example, a microcontroller. The control device 80 may be a single control device providing centralized control or may be a plurality of control devices providing decentralized control in a mutually cooperative manner.

For example, the control device 80 controls supply of power from the natural-energy power generator 10 to the storage system 100, based on information on electric power obtained from the natural-energy power generator 10, the load unit 60, and the electric power line 70, and based on information on the remaining storage amount of each of electric power accumulator 20 and the hydrogen storage device 40 obtained from the storage system 100. For example, the control device 80 controls distribution of power from the storage system 100 to the load unit 60, based on information on the electric power and information on the remaining storage amount.

Specifically, the control device 80, performs accumulated energy control that controls the ratio (supply ratio) of power supplied from the natural-energy power generator 10 to each of the hydrogen-type power storage device 90 (i.e. the hydrogen production device 30 and the hydrogen storage device 40) and the electric power accumulator 20. The control device 80 performs released energy control that controls the ratio (supply ratio) of power supplied to the load unit 60 from each of the electric power accumulator 20 and the hydrogen-type power storage device 90 (i.e. the hydrogen storage device 40 and the fuel cell system 50). Based on the ratios controlled by the accumulated energy control and the released energy control, the control device 80 provides control for, e.g., charged power and discharged power of the electric power accumulator 20, the amount of hydrogen production of the hydrogen production device 30, and generated power of the fuel cell system 50. The control device 80 may convert the amount of stored hydrogen of the hydrogen storage device 40 into the amount of stored power, as necessary. In this case, the stored power amount of the hydrogen storage device 40 may be the generated power amount obtained when assumed that the fuel cell system 50 generates electricity using the full amount of the stored hydrogen amount of the hydrogen storage device 40.

### <Load Unit>

The load unit 60 is, for example, a household home appliance and consumes electric power in accordance with the use of the home appliance. The load unit 60 is an appliance that is supplied for operation with electric power from at least one of the natural-energy power generator 10, the storage system 100, and the electric power line 70. Electric power supplied to the load unit 60 is measured by a measurement device (not shown) such as a wattmeter, and information on electric power measured is sent to the control device 80.

### <Electric Power Line>

The electric power line 70 supplies electric power to the load unit 60 when the load unit 60 is not supplied with electric power from the natural-energy power generator 10 and the storage system 100. When electric power supplied from the natural-energy power generator 10 or the storage system 100 to the load unit 60 is smaller than the demanded power of the load unit 60, electric power for the difference is supplied from the electric power line 70 to the load unit 60. When the total of power generated by the natural-energy power generator 10 and electric power distributed from the storage system 100 is larger than electric power consumed by the load unit 60, electric power for the difference flows back to the electric power line 70. The measurement device such as a wattmeter measures electric power from the electric power line 70 received by the energy network 110 and electric power from the energy network 110 flowing back to the electric power line 70 and sends information on measured electric power to the control device 80.

### <Detailed Description of Control Device>

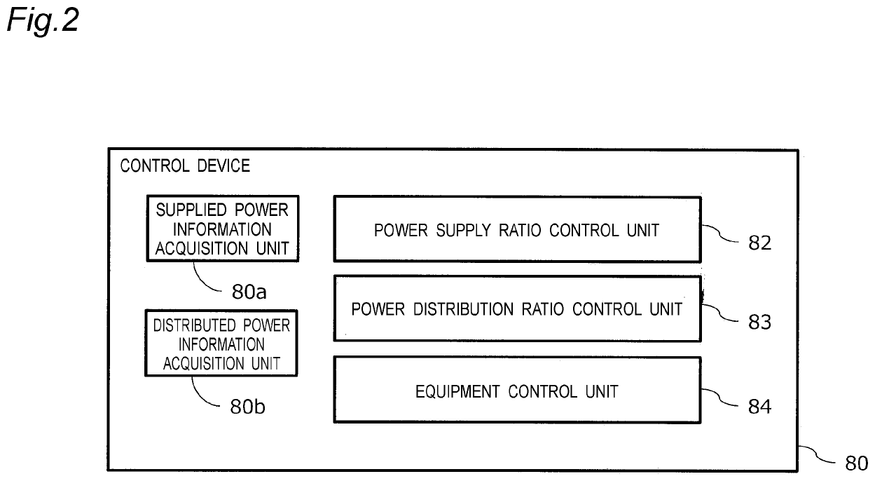

The control device 80 will next be described in detail. FIG. 2 is a view showing an example of a main configuration of the control device 80.

The control device 80 includes a supplied power information acquisition unit 80a, a distributed power information acquisition unit 80b, a power supply ratio control unit 82, a power distribution ratio control unit 83, and an equipment control unit 84. These are function blocks implemented by a processor included in the control device 80 reading and executing a predetermined program stored in a memory included in the control device 80.

The supplied power information acquisition unit 80a acquires information related to electric power that the electric power accumulator 20 can charge per unit time and information related to electric power that the hydrogen production device 30 can consume per unit time. Specifically, these pieces of information may be, for example, rated equipment capacities, or may be information on electric power suppliable per unit time that varies depending on the remaining amount of charge, the intradevice temperature, etc. in the case of the electric power accumulator 20 and that varies depending on the remaining amount of storage, the device temperature, etc. of the hydrogen storage device 40 in the case of the hydrogen production device 30. These pieces of information may be, instead of the rated equipment capacities, values restricted with respect to the rated capacities, such as e.g. 90% of the rated capacities. That is, these pieces of information may be any information as long as it is related to the maximum value of energy that the storage system 100 can store per unit time. The supplied power information acquisition unit 80a notifies the power supply ratio control unit 82 of the acquired information on supplied power per unit time as the upper limit.

The distributed power information acquisition unit 80b acquires information related to electric power that the electric power accumulator 20 can discharge per unit time and information related to electric power that the fuel cell system 50 can generate electricity per unit time. Specifically, these pieces of information may be, for example, rated equipment capacities, or may be information on electric power distributable per unit time that varies depending on the remaining amount of charge, the intradevice temperature, etc. in the case of the electric power accumulator 20 and that varies depending on the remaining amount of storage, the device temperature, etc. of the hydrogen storage device 40 in the case of the fuel cell system 50. These pieces of information may be, instead of the rated equipment capacities, values restricted with respect to the rated capacities, such as e.g. 90% of the rated capacities. That is, these pieces of information may be any information as long as it is related to the maximum value of energy that the storage system 100 can discharge per unit time. The distributed power information acquisition unit 80b notifies the power distribution ratio control unit 83 of the acquired information on distributed power per unit time as the upper limit.

The power supply ratio control unit 82 controls the ratio (supply ratio) between electric power supplied to the electric power accumulator 20 and electric power supplied to the hydrogen production device 30, of power supplied from the natural-energy power generator 10 to the storage system 100. This supplied power ratio control is performed based on information on supplied power per unit time acquired from the supplied power information acquisition unit 80a by the power supply ratio control unit 82.

For example, the power supply ratio control unit 82 has a function of controlling the ratio between electric power supplied to the electric power accumulator 20 and electric power supplied to the hydrogen production device 30, of power supplied from the natural-energy power generator 10 to the storage system 100 when surplus electric power of the natural-energy power generator 10 is smaller than electric power that the electric power accumulator 20 can charge per unit time.

The power distribution ratio control unit 83 controls the ratio (supply ratio) between electric power distributed from the electric power accumulator 20 and electric power distributed from the fuel cell system 50, of power distributed from the storage system 100 to the load unit 60. This distributed power ratio control is performed based on information on distributed power per unit time acquired from the distributed power information acquisition unit 80b by the power distribution ratio control unit 83.

For example, the power distribution ratio control unit 83 has a function of controlling the ratio between electric power distributed from the electric power accumulator 20 and electric power distributed from fuel cell system 50, of power distributed from the storage system 100 to the load unit 60 when demanded power of the load unit 60 is smaller than electric power that the electric power accumulator 20 can discharge per unit time.

Based on the power supply ratio controlled by the power supply ratio control unit 82, the equipment control unit 84 provides control for, e.g., charged power of the electric power accumulator 20 and the amount of hydrogen production of the hydrogen production device 30. Based on the power distribution ratio controlled by the power distribution ratio control unit 83, the equipment control unit 84 provides controls for, e.g., discharged power of the electric power accumulator 20 and the generated power of the fuel cell system 50.

Subjects of control are ones allowing control of power supplied to the storage system 100 and of power distributed from the storage system 100. For example, the power amount per certain period of time or per unit time may be controlled for the charged power and discharged power of the electric power accumulator 20. The amount of hydrogen produced by the hydrogen production device 30 may be a value in terms of the power amount. In this case, the conversion value may be the power amount supplied (input) to the hydrogen production device 30 when producing the produced hydrogen. The subject of control may be the power amount per a certain period of time or per unit time input to the hydrogen production device. The control subject may also be a value taking into consideration the electric power required for operating a device such as a cooling water circulation pump.

The control device 80 may have a configuration where the equipment control unit 84 is separated therefrom. For example, configuration may be such that the equipment control unit 84 separated from the control device 80 is disposed in the vicinity of the devices arranged in the storage system 100. For example, the control device 80 may include the first and second control devices (not shown) that provide decentralized control in a mutually cooperative manner. In such a case, for example, the first control device may include the supplied power information acquisition unit 80a, the distributed power information acquisition unit 80b, and the power distribution ratio control unit 83, while the second control device may include the equipment control unit 84.

### <Accumulated Energy Control>

Specific contents will then be described of accumulated energy control of the control device 80 that controls the ratio of power supplied from the natural-energy power generator 10 to the hydrogen-type power storage device 90 and to the electric power accumulator 20.

First, in the energy network 110, the amount exceeding demanded power of the load unit 60, of power generated by the natural-energy power generator 10, becomes surplus electric power. This surplus electric power is stored in the storage system 100 and is distributed to the load unit 60 at required timings.

As described above, when comparing the electric power accumulator 20 and the hydrogen-type power storage device 90 making up the storage system 100 with each other, the electric power accumulator 20 is larger in chargeable power amount per unit time and smaller in the storable power amount than the hydrogen-type power storage device 90. Considering the energy efficiency, it is appropriate to give priority to charging the electric power accumulator 20 having higher energy efficiency than the hydrogen-type power storage device 90.

On the premise of such features of the basic devices, it will be described, using a surplus electric power model simplified for explanation, how surplus electric power is distributed and accumulated in the storage system 100. In the explanation, installed capacities of the devices are set as follows, and a surplus electric power model of 5 consecutive time zones from T₁ up to T₅ is used. Numerical values indicated in the surplus electric power model are indices each representing the power amount.

Electric power chargeable per unit time/Storable power amount (Total power amount)
Electric power accumulator: 100/300
Hydrogen-type power storage device: 100/1000

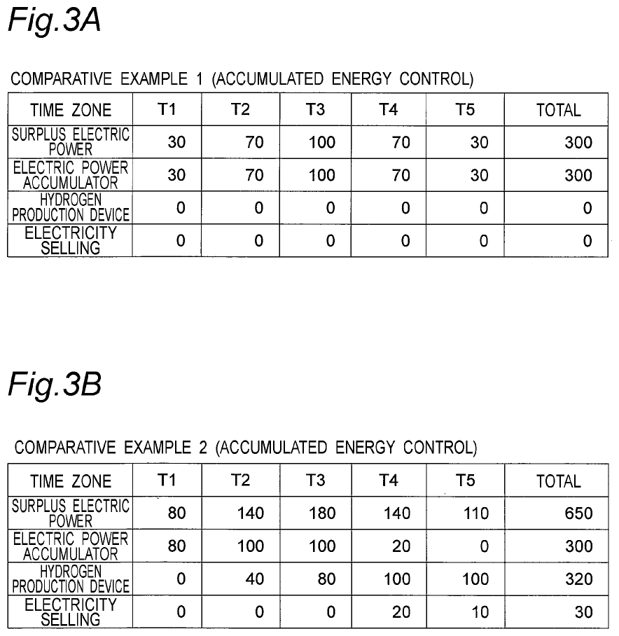

Contents of accumulated energy control according to Comparative Example 1 will first be described using a surplus electric power model shown in FIG. 3A. The accumulated energy control according to Comparative Example 1 employs a control method in which priority is given to charging the electric power accumulator having higher energy efficiency than the hydrogen-type power storage device so that the amount that cannot be accumulated in the electric power accumulator is supplied to the hydrogen-type power storage device whereas the amount that cannot be stored in the hydrogen-type power storage device is supplied to electricity selling.

The surplus electric power model of Comparative Example 1 shown in FIG. 3A shows surplus electric power in the time zones T₁ to T₅, electric power supplied to the electric power accumulator, electric power supplied to the hydrogen-type power storage device, and electric power sold through the electric power line. As shown in FIG. 3A, in the situation where surplus electric power is relatively small in the time zones T₁ to T₅, all of the surplus electric power is supplied to the electric power accumulator having higher energy efficiency. For this reason, no surplus electric power is supplied to the hydrogen-type power storage device as well as to the electricity selling.

Contents of accumulated energy control according to Comparative Example 2 will then be described using a surplus electric power model shown in FIG. 3B. The surplus electric power model of Comparative Example 2 shown in FIG. 3B shows the situation where a larger surplus electric power amount occurs in the time zones T₁ to T₅, as compared with Comparative Example 1. Comparative Example 2 also employs the same control method as in Comparative Example 1.

First, in the time zone T₁, all of surplus electric power 80 is supplied to and accumulated in the electric power accumulator, but no surplus electric power is supplied to the hydrogen-type power storage device and to the electricity selling. Next, in the time zone T₂, the surplus electric power increases to 140 so that electric power 100 chargeable per unit time into the electric power accumulator is supplied to the electric power accumulator, while remaining surplus electric power amount 40 is supplied to the hydrogen-type power storage device for storage as hydrogen. Similarly, in the time zone T₃, electric power 100 chargeable per unit time into the electric power accumulator, relative to surplus electric power 180, is supplied to the electric power accumulator, while remaining surplus electric power amount 80 is supplied to the hydrogen-type power storage device for storage as hydrogen.

Next, in the time zone T₄, electric power 20 up to the upper limit of the power amount storable in the electric power accumulator is supplied to the electric power accumulator. On the other hand, electric power 100 chargeable per unit time into the hydrogen-type power storage device, relative to remaining surplus electric power amount 120, is supplied to the hydrogen-type power storage device, while remaining surplus electric power amount 20 is supplied to the electricity selling. Similarly, in the time zone T₅, no surplus electric power can be supplied to the electric power accumulator so that electric power 100 chargeable per unit time into the hydrogen-type power storage device, relative to surplus electric power 110, is supplied to the hydrogen-type power storage device, while remaining surplus electric power amount 10 is supplied to the electricity selling.

In the accumulated energy control of Comparative Example 2, power amount 300, relative to surplus electric power amount 650 from the time zone T₁ up to the time zone T₅, is accumulated in the electric power accumulator, while power amount 320 is stored in the hydrogen-type power storage device. Although the hydrogen-type power storage device still has room for the storable power amount (has room 680 in the power amount accumulated), power amount 30 is supplied to the electricity selling.

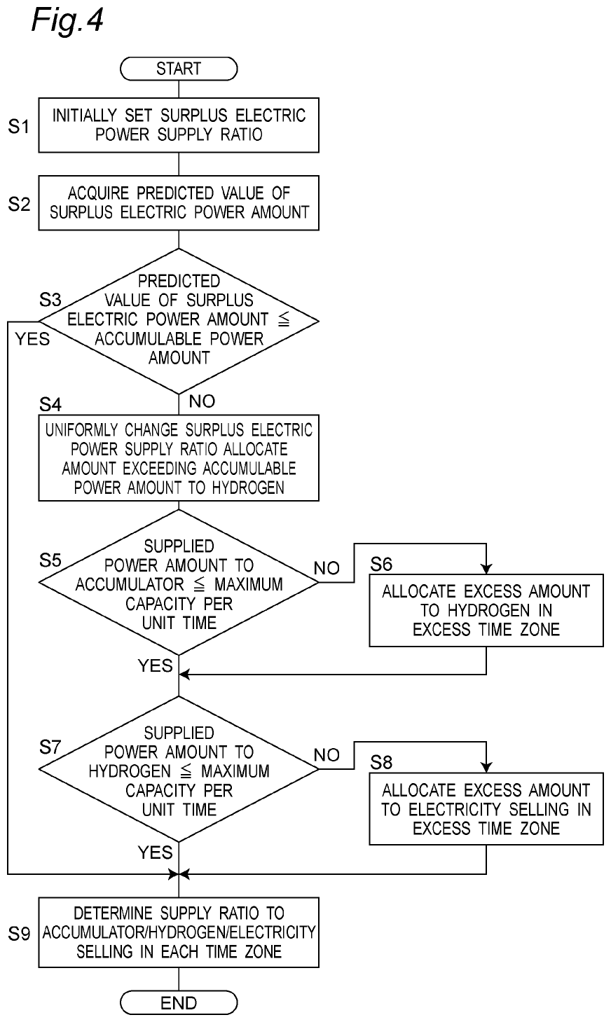

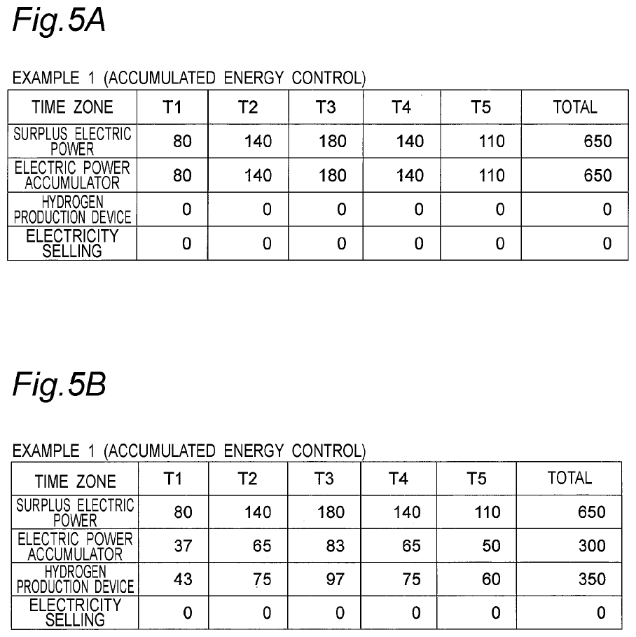

The accumulated energy control according to the first embodiment will then be described with reference to a flowchart shown in FIG. 4 and surplus electric power models of Example 1 shown in FIGS. 5A and 5B. The control described below is executed by the control device 80 including the supplied power information acquisition unit 80a, the power supply ratio control unit 82, and the equipment control unit 84.

At step S1 of FIG. 4, the surplus electric power supply ratio (i.e. supplied power ratio) to the electric power accumulator 20 and the hydrogen-type power storage device 90 is initially set. Specifically, in the power supply ratio control unit 82, 100% for the electric power accumulator 20 and 0% for the hydrogen-type power storage device 90 are previously set as initially set values of the supply ratio, and this initially set supply ratio is used.

Information on predicted value of the surplus electric power amount in the natural-energy power generator 10 is then acquired (step S2). This predicted value of the surplus electric power amount may be input and set by the user. Alternatively, it may be set based on past accumulated data or may be set based on e.g. the season of the year or the time zone of the day. The predicted value of the surplus electric power amount is set for each time zone, for example, for each individual time zone of the time zones T₁ to T₅. In the surplus electric power models of Example 1 shown in FIGS. 5A and 5B, the amounts of the surplus electric power in the time zones T₁ to T₅ are the same as those of the surplus electric power model of Comparative Example 2. The surplus electric power model of FIG. 5A shows the state (i.e. the state where 100% is distributed to the electric power accumulator 20) in which the predicted value of the surplus electric power amount is distributed as the surplus electric power at the initially set supply ratio in the time zones T₁ to T₅. The surplus electric power amount means the integrated value of surplus electric power of the natural-energy power generator 10 in a predetermined period of time. The predetermined period of time may be individual time zone or a plurality of consecutive time zones, of the time zones T₁ to T₅. For example, if the predetermined period of time is the time zones T₁ to T₅, the surplus electric power amount may be referred to as the total value of the amounts of surplus electric power from the time zone T₁ up to the time zone T₅.

It is then judged whether the total value of the predicted values of the surplus electric power amount from the time zone T₁ up to the time zone T₅ is within the power amount (total power amount) accumulable in the electric power accumulator 20 (step S3). This judgment is made, for example, by the control device 80 calculating the power amount storable in the electric power accumulator 20, based on the remaining amount of charge of the electric power accumulator 20 acquired by the supplied power information acquisition unit 80a and on the equipment rated capacities. If the total value of the predicted values of the surplus electric power amount from the time zone T₁ up to the time zone T₅ is judged to be within the power amount storable in the electric power accumulator 20, the power supply ratio control unit 82 determines the surplus electric power supply ratio in each time zone as being not changed from the initial setting (step S9). Afterward, the equipment control unit 84 controls supply of surplus electric power to the electric power accumulator 20 and to the hydrogen-type power storage device 90, based on the determined surplus electric power supply ratio.

In this Example 1, it is judged total value 650 of the predicted values of the amounts of surplus electric power from the time zone T₁ up to the time zone T₅ exceeds power amount 300 accumulable in the electric power accumulator 20. As a result, procedure goes to step S4 without going to step S9.

At step S4, the power supply ratio control unit 82 changes the supply ratios uniformly so that the amount exceeding the power amount accumulable in the electric power accumulator 20, relative to the total value of the predicted values of the amounts of surplus electric power from the time zone T₁ up to the time zone T₅, is distributed to the hydrogen-type power storage device 90. For example, power amount 350 exceeding power amount 300 accumulable in the electric power accumulator 20, relative to total value 650 of the predicted values of the amounts of surplus electric power, is distributed to the hydrogen-type power storage device 90. At this time, the supply ratios are uniformly changed and set (to certain value) in the time zones of T₁ to T₅. Specifically, the ratio between the supply amount of surplus electric power to the electric power accumulator 20 and the supply amount to the hydrogen-type power storage device 90 is set to 46.2:53.8. The surplus electric power model of FIG. 5B shows the example where the ratio between the supply amount of surplus electric power to the electric power accumulator 20 and the supply amount to the hydrogen-type power storage device 90 is set to 46.2:53.8 in the time zones T₁ to T₅.

It is then judged whether the supply surplus electric power amount to the electric power accumulator 20 in each of the time zones T₁ to T₅ is within the power amount chargeable per unit time into the electric power accumulator 20 (step S5). If the supply surplus electric power amount to the electric power accumulator 20 is judged as exceeding the power amount chargeable per unit time, the excess power amount is allocated to the hydrogen-type power storage device 90 in the excess time zone at step S6. In this Example 1, it is judged that the supply surplus electric power amount to the electric power accumulator 20 is within power amount 100 chargeable per unit time in the time zones T₁ to T₅, allowing shift to step S7.

It is then judged whether the supply surplus electric power amount to the hydrogen-type power storage device 90 in each of the time zones T₁ to T₅ is within the power amount chargeable per unit time into the hydrogen-type power storage device 90 (step S7). If the supply surplus electric power amount to the hydrogen-type power storage device 90 is judged as exceeding the power amount chargeable per unit time, the excess power amount is allocated to the electricity selling in the excess time zone at step S8. In this Example 1, it is judged that the supply surplus electric power amount to the hydrogen-type power storage device 90 is within power amount 100 chargeable per unit time in the time zones T₁ to T₅, allowing shift to step S9.

At step S9, the power supply ratio control unit 82 determines the supply ratio of surplus electric power in the time zones T₁ to T₅, and the equipment control unit 84 controls supply of surplus electric power to the electric power accumulator 20, the hydrogen-type power storage device 90, and the electricity selling, based on the determined surplus electric power supply ratio. In this Example 1, the surplus electric power supply ratio is determined as in the surplus electric power model of FIG. 5B so that the accumulated energy control is performed at the determined supply ratio.

The above accumulated energy control method of this embodiment is an example, and other various methods may be employed so as to achieve the effects of this embodiment. For example, a method may be employed in which the control device 80 executes the first control of supplying surplus electric power to each of the electric power accumulator 20 and the hydrogen generated power system 10 in a time zone where surplus electric power of the natural-energy power generator 10 is smaller than electric power chargeable into the electric power accumulator 20. For example, a method may be employed in which the control device 80 executes the second control of making surplus electric power supplied to the electric power accumulator 20 smaller than electric power chargeable into the electric power accumulator 20 in a time zone where surplus electric power of the natural-energy power generator 10 is larger than electric power chargeable into the electric power accumulator 20. In the above Example 1, the power supply ratio control in the time zone T₁ corresponds to the first control, while the power supply ratio control in the time zones T₂ to T₅ corresponds to the second control.

For example, the control device 80 may execute the first control when the surplus electric power amount of the natural-energy power generator 10 is larger than the power amount chargeable into the electric power accumulator 20. For example, the control device 80 may execute the first and second controls when the surplus electric power amount of the natural-energy power generator 10 is larger than the power amount chargeable into the electric power accumulator 20. In the above Example 1, the control device 80 executes the first and second controls, based on the demanded power amounts from the time zone T₁ up to the time zone T₅.

### <Released Energy Control>

Specific contents will next be described of the released energy control, performed by the control device 80, of controlling the ratio between electric power suppled from the electric power accumulator 20 to the load unit 60 and electric power supplied from the fuel cell system 50 to the load unit 60.

In the energy network 110, surplus electric power exceeding the demanded power of the load unit 60, of power generated by the natural-energy power generator 10, is stored in the storage system 100. Electric power stored in the storage system 100 is distributed to the load unit 60 depending on the demanded power of the load unit 60.

As described above, when comparing the electric power accumulator 20 and the hydrogen-type power storage device 90 making up the storage system 100 with each other, the electric power accumulator 20 is larger in dischargeable power amount per unit time and smaller in storable power amount than the hydrogen-type power storage device 90. Considering the energy efficiency, it is appropriate to give priority to discharging the electric power accumulator 20 having higher energy efficiency than the hydrogen-type power storage device 90.

On the premise of such features of the basic devices, it will be described, using a demanded power model simplified for explanation, how electric power stored in the storage system 100 is distributed to the demanded power of the load unit 60. In the explanation, installed capacities of the devices are set as follows, and a demanded power model of 5 consecutive time zones from T₁₁ up to T₁₅ is used. Numerical values indicated in the demanded power model are indices each representing the power amount.

Electric power dischargeable per unit time/Storable power amount (Total power amount)
Electric power accumulator: 100/300
Hydrogen-type power storage device: 100/1000

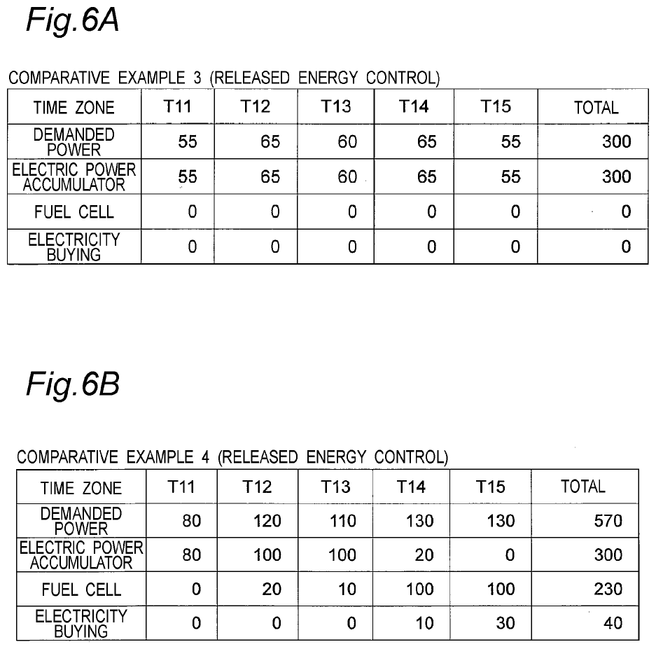

Contents of released energy control according to Comparative Example 3 will first be described using a demanded power model shown in FIG. 6A. In the released energy control according to Comparative Example 3, priority is given to discharge from the electric power accumulator having higher energy efficiency than the hydrogen-type power storage device. A control method is employed in which the amount that cannot be covered by the electric power accumulator is supplied from the hydrogen-type power storage device and further in which the amount that cannot be covered by the hydrogen-type power storage device is supplied from electricity buying.

The demanded power model of Comparative Example 3 shown in FIG. 6A shows demanded power in time zones T₁₁ to T₁₅, electric power distributed from the electric power accumulator, electric power distributed from the hydrogen-type power storage device, and electric power bought through the electric power line. As shown in FIG. 6A, in the situation where demanded power is relatively small in the time zones T₁₁ to T₁₅, electric power is distributed from only the electric power accumulator having higher energy efficiency to the demanded power. For this reason, no electric power is distributed from the hydrogen-type power storage device and electricity buying to the demanded power.

Contents of released energy control according to Comparative Example 4 will then be described using a demanded power model shown in FIG. 6B. The demanded power model of Comparative Example 4 shown in FIG. 6B shows the situation where a larger demanded power amount occurs in the time zones T₁₁ to T₁₅, as compared with Comparative Example 3. Comparative Example 4 also employs the same control method as in Comparative Example 3.

First, in the time zone T₁₁, electric power is distributed exclusively from the electric power accumulator to demanded power 80, and hence no electric power is distributed from the hydrogen-type power storage device and the electricity buying to the demanded power. Next, in the time zone 112, the demanded power increases to 120, and electric power 100 dischargeable per unit time from the electric power accumulator is distributed from the electric power accumulator. On the other hand, shortfall 20 relative to demanded power is distributed from the hydrogen-type power storage device. Similarly, in the time zone T₁₃, electric power 100 dischargeable per unit time from the electric power accumulator, relative to demanded power 110, is distributed from the electric power accumulator, and shortfall 10 is distributed from the hydrogen-type power storage device.

Next, in the time zone T₁₄, electric power 20 up to the upper limit of the power amount stored in the electric power accumulator, relative to demanded power 130, is distributed from the electric power accumulator. On the other hand, electric power 100 dischargeable per unit time from the hydrogen-type power storage device, relative to shortfall 110, is distributed from the hydrogen-type power storage device. Remaining power amount 10 is distributed from the electricity buying. Similarly, in the time zone T₁₅, the electric power accumulator cannot distribute electric power to the demanded power so that electric power 100 dischargeable per unit time from the hydrogen-type power storage device, relative to demanded power 130, is distributed from the hydrogen-type power storage device, while shortfall 30 is distributed from the electricity buying.

In the released energy control of Comparative Example 4, power amount 300, relative to demanded power amounts (total) 570 from the time zone T₁₁ up to the time zone T₁₅, is distributed from the electric power accumulator, while power amount 230 is distributed from the hydrogen-type power storage device. Power amount 40 is supplied from the electricity buying despite the stored power amount remaining left (stored power amount 770 left) in the hydrogen-type power storage device.

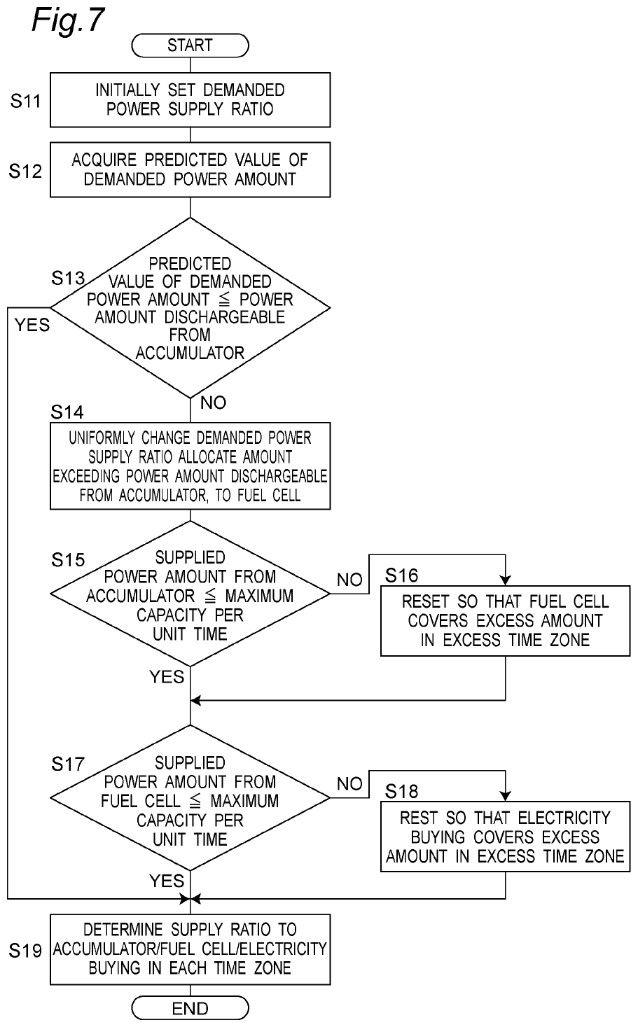

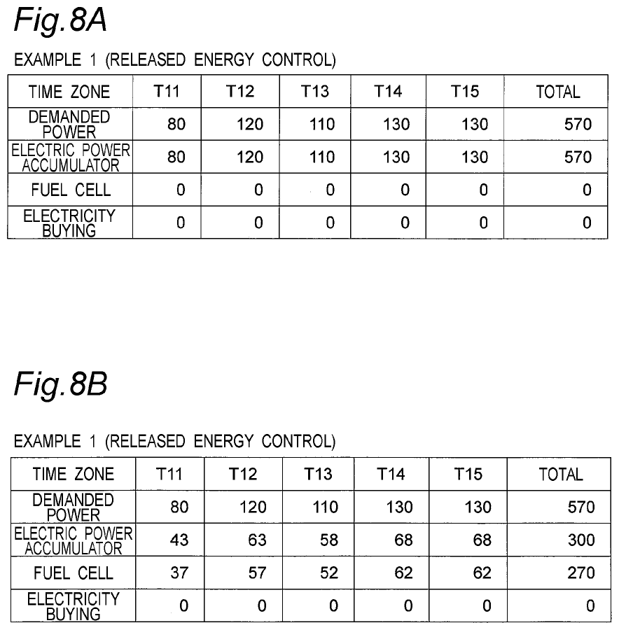

The released energy control according to the first embodiment will next be described with reference to a flowchart shown in FIG. 7 and demanded power models according to Example 1 shown in FIGS. 8A and 8B. The control described below is executed by the control device 80 including the distributed power information acquisition unit 80b, the power distribution ratio control unit 83, and the equipment control unit 84.

At step S11 of FIG. 7, the ratio of supply (i.e. the ratio of power to be distributed) from the electric power accumulator 20 and the hydrogen-type power storage device 90 to the demanded power is initially set. Specifically, in the power distribution ratio control unit 83, 100% from the electric power accumulator 20 and 0% from the hydrogen-type power storage device 90 are previously set as initially set values of the supply ratio, and this initially set supply ratio is used. In the first embodiment, power distribution from the hydrogen-type power storage device 90 to the load unit 60 specifically means power distribution from the fuel cell system 50 to the load unit 60. The dischargeable power amount accumulated in the hydrogen-type power storage device 90 means the power amount dischargeable from the fuel cell system 50 using hydrogen accumulated in the hydrogen storage device 40.

Information on predicted value of the demanded power amount of the load unit 60 is then acquired (step S12). This predicted value of the demanded power amount may be input and set by the user. Alternatively, it may be set based on past accumulated data or may be set based on e.g. the season of the year or the time zone of the day. The predicted value of the demanded power amount is set for each time zone, for example, for each individual time zone of the time zones T₁₁ to T₁₅. In the demanded power models of Example 1 shown in FIGS. 8A and 86, the amounts of the demanded power in the time zones T₁₁ to T₁₅ are the same as those of the demanded power model of Comparative Example 4. The demanded power model of FIG. 8A shows the state (i.e. the state where 100% is distributed from the electric power accumulator 20) in which the predicted value of the demanded power amount is distributed as the distributed electric power at the initially set supply ratio in the time zones T₁₁ to T₁₅. The demanded power amount means the integrated value of demanded powers of the load unit 60 in a predetermined period of time. The predetermined period of time may be individual time zone or a plurality of consecutive time zones, of the time zones T₁₁ to T₁₅. For example, if the predetermined period of time is the time zones T₁₁ to T₁₅, the demanded power amount may be referred to as the total value of the demanded power amounts from the time zone T₁ up to the time zone T₅.

It is then judged whether the total value of the predicted values of the demanded power amount from the time zone T₁₁ up to the time zone T₁₅ is within the power amount (total power amount) dischargeable from the electric power accumulator 20 (step S13). This judgment is made, for example, by the control device 80 calculating the power amount dischargeable from the electric power accumulator 20, based on the remaining amount of charge of the electric power accumulator 20 acquired by the distributed power information acquisition unit 80b and on the equipment rated capacities. If the total value of the predicted values of the demanded power amount from the time zone T₁ up to the time zone T₅ is judged to be within the power amount dischargeable from the electric power accumulator 20, the power distribution ratio control unit 83 determines the power supply ratio relative to the demanded power in each time zone as being not changed from the initial setting (step S19). Afterward, the equipment control unit 84 controls the power supply from the electric power accumulator 20 and the hydrogen-type power storage device 90 to the load unit 60, based on the determined ratio of power supply to the demanded power.

It is judged in this Example 1 that total value 570 of the predicted values of the demanded power amount from the time zone T₁₁ to the time zone T₁₅ exceeds power amount 300 dischargeable from the electric power accumulator 20. In consequence, procedure goes to step S14 without going to step S19.

At step S14, the power distribution ratio control unit 83 changes the supply ratios uniformly so that the amount exceeding the power amount dischargeable from the electric power accumulator 20, relative to the total value of the predicted values of the demanded power amount from the time zone up to the time zone 115, is distributed to the hydrogen-type power storage device 90 i.e. the fuel cell system 50. For example, power amount 270 exceeding power amount 300 dischargeable from the electric power accumulator 20, relative to total value 570 of the predicted values of demanded power amount, is distributed to the fuel cell system 50. At this time, the supply ratios are uniformly changed and set (to certain value) in the time zones of T₁ to T₅. Specifically, the ratio between the distributed power amount from the electric power accumulator 20 to the demanded power and the distributed power amount from the fuel cell system 50 to the demanded power is set to 52.6:47.4. The demanded power model of FIG. 8B shows the example where the ratio between the distributed power amount from the electric power accumulator 20 to the demanded power and the distributed power amount from the fuel cell system 50 to the demanded power is set to 52.6:47.4 in the time zones T₁₁ to T₁₅.

It is then judged whether the amount of distributed power (supplied power amount) from the electric power accumulator 20 in each of the time zones T₁ to T₅ is within the power amount dischargeable per unit time from the electric power accumulator 20 (step S15). If the amount of distributed power from the electric power accumulator 20 is judged as exceeding the power amount dischargeable per unit time, the excess power amount is allocated to the fuel cell system 50 in the excess time zone at step S16. In this Example 1, it is judged that the amount of distributed power from the electric power accumulator 20 is within power amount 100 dischargeable per unit time in the time zones T₁₁ to Tis, allowing shift to step S17.

It is then judged whether the amount of distributed power (supplied power amount) from the fuel cell system 50 in each of the time zones T₁ to T₅ is within the power amount (maximum discharge capacity per unit time) dischargeable per unit time from the fuel cell system 50 (step S17). If the amount of distributed power from the fuel cell system 50 is judged as exceeding the power amount dischargeable per unit time, the supply ratio is reset at step S18 so that excess power amount is covered by the electricity buying in the excess time zone. In this Example 1, it is judged that the amount of distributed power from the fuel cell system 50 is within power amount 100 dischargeable per unit time in the time zones T₁₁ to T₁₅, allowing shift to step S19.

At step S19, the power distribution ratio control unit 83 determines the ratio of power supply to the demanded power in the time zones T₁₁ to T₁₅, and the equipment control unit 84 controls the power supply from the electric power accumulator 20, the hydrogen-type power storage device 90, and the electricity buying, based on the determined power supply ratio. In this Example 1, the ratio of power supply to the demanded power is determined as in the demanded power model of FIG. 8B so that the released energy control is performed at the determined supply ratio.

The above released energy control method of this embodiment is an example, and other various methods may be employed so as to achieve the effects of this embodiment. For example, a method may be employed in which the control device 80 executes the first control of supplying electric power from each of the electric power accumulator 20 and the fuel cell system 50 to the load unit 60 in a time zone where demanded power of the load unit 60 is smaller than electric power dischargeable from the electric power accumulator 20. For example, a method may be employed in which the control device 80 executes the second control of making electric power distributed from the electric power accumulator 20 to the load unit 60 smaller than electric power dischargeable from the electric power accumulator 20 in a time zone where demanded power of the load unit 60 is larger than electric power dischargeable from the electric power accumulator 20. In the above Example 1, the power supply ratio control in the time zone T₁₁ corresponds to the first control, while the power supply ratio control in the time zones T₁₂ to T₁₅ corresponds to the second control.

For example, the control device 80 may execute the first control when the demanded power amount of the load unit 60 is larger than the power amount dischargeable from the electric power accumulator 20. For example, the control device 80 may execute the first and second controls when the demanded power amount of the load unit 60 is larger than the power amount dischargeable from the electric power accumulator 20. In the above Example 1, the control device 80 executes the first and second controls, based on the demanded power amounts from the time zone T₁₁ up to the time zone T₁₅.

In the accumulated energy control, in the case of the control method of Comparative Example 2 merely preferentially using the electric power accumulator having high energy efficiency, electric power is supplied to the electricity selling although the hydrogen-type power storage device still has room for the storable power amount. In this manner, if surplus electric power generated by the natural-energy power generator is supplied to the electricity selling without being accumulated in spite of having room for storage capacity of the storage system, loss in energy accumulation occurs, making it impossible to enhance the surplus energy efficiency.

In the released energy control, in the case of the control method of Comparative Example 4 merely preferentially using the electric power accumulator having high energy efficiency, electric power is supplied from the electricity buying although the hydrogen-type power storage device still leave the power amount stored therein. In this manner, if electric power is supplied from the electricity buying despite leaving the accumulated energy in the storage system accumulating surplus electric power generated by the natural-energy power generator, loss in use of the accumulated energy occurs, rendering it impossible to enhance the use efficiency of the accumulated energy.

On the contrary, in the accumulated energy control of Example 1 of the first embodiment, on the premise that the electric power accumulator 20 having higher energy efficiency is used with priority, if a predetermined condition (e.g. step S3 of FIG. 4) is satisfied, electric power is distributed to the hydrogen-type power storage device 90 for energy accumulation while giving the electric power accumulator 20 room for the amount of accumulation. This enables the time taken for the amount of accumulated power of the electric power accumulator 20 to reach the upper limit to be delayed, as compared with Comparative Example 2. This results in reduction of surplus electric power supplied to the electricity selling, decrease of energy accumulation loss, and improvement of surplus energy accumulation efficiency.

In the released energy control of Example 1 of the first embodiment, on the premise that the electric power accumulator 20 having higher energy efficiency is used preferentially, if a predetermined condition (e.g. step S13 of FIG. 7) is satisfied, electric power is distributed from the hydrogen-type power storage device 90 while giving the electric power accumulator 20 room for the power amount accumulation. This enables the time taken for the amount of accumulated power of the electric power accumulator 20 to reach the lower limit to be delayed, as compared with Comparative Example 4. This results in reduction of power supplied from the electricity buying to the demanded power, decrease of accumulated energy use loss, and enhancement of accumulated energy use efficiency.

As described hereinabove, according to the first embodiment, the control device 80 uses both the electric power accumulator 20 and the hydrogen-type power storage device 90 to receive surplus electric power of the natural-energy power generator 10 before the free space for charging the electric power accumulator 20 runs out. In consequence, the possibility can be lowered that the surplus electric power accumulation loss may occur due to electricity selling, as compared with the case where the electric power accumulator 20 merely preferentially receives electric power. It becomes thus possible to increase the power amount suppliable from the storage system 100 when a demanded power occurs at the load unit 60, leading to efficient energy control.

When a demanded power occurs at the load unit 60, control device 80 uses both the electric power accumulator 20 and the fuel cell system 50 to distribute electric power to the load unit 60 before the remaining amount of accumulated power reaches the lower limit. In consequence, the possibility can be lowered that the amount of electricity buying may increase, as compared with the case where the electric power accumulator 20 merely preferentially distributes electric power. It becomes thus possible to increase the power amount suppliable from the storage system 100 when a demanded power occurs at the load unit 60, leading to efficient energy control.

### Second Embodiment

A method of controlling an electric power supply system according to a second embodiment of the present disclosure will next be described. In the above first embodiment, the case was taken as an example where the power supply ratios are uniformly changed in all the time zones when allocating to the hydrogen-type power storage device the power amount exceeding the power amount storable in the electric power accumulator 20 relative to the total value of the predicted values of the surplus electric power amount. Similarly, the case was taken as an example where the power supply ratios are uniformly changed in all the time zones when allocating to the fuel cell system 50 the power amount exceeding the power amount dischargeable from the electric power accumulator 20 relative to the total value of the predicted values of the demanded power amount. The method of controlling an electric power supply system of the present disclosure is not limited to such cases. In the second embodiment, description will be given, by way of example, of the case of employing a control method including time zones in which 100% of power is supplied to the hydrogen-type power storage device 90 or to the fuel cell system 50 and time zones in which the power supply ratios are uniformly set, among all the time zones. In the following description, the same reference numerals, step numbers, etc. are imparted to substantially the same constituent elements as those in the electric power supply system of the first embodiment, and explanations thereof will be omitted. Hereinafter, differences from the first embodiment will mainly be described.

### <Accumulated Energy Control>

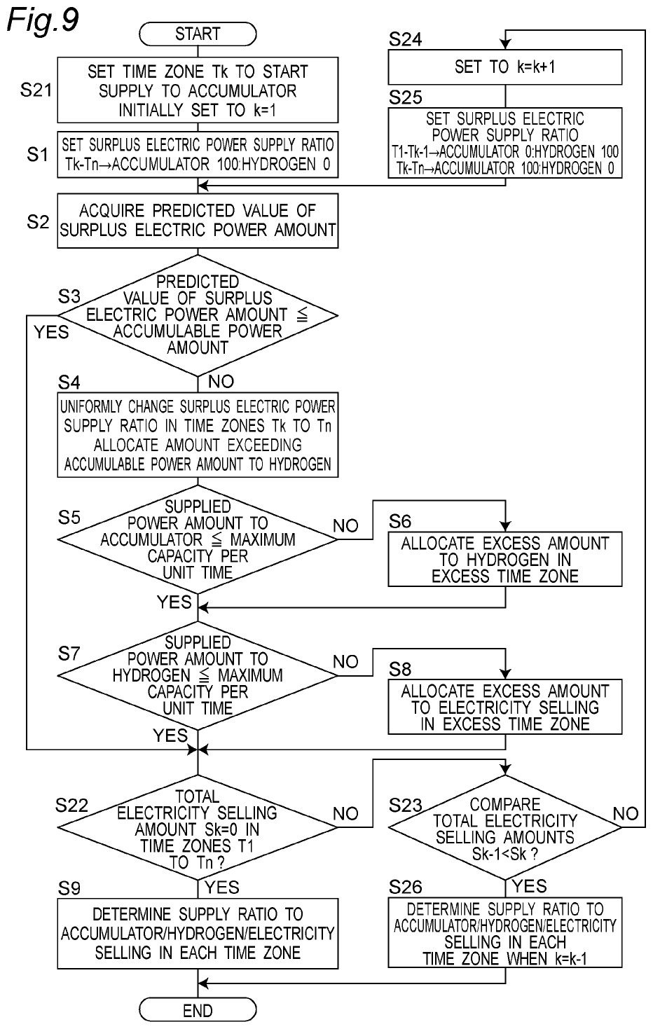

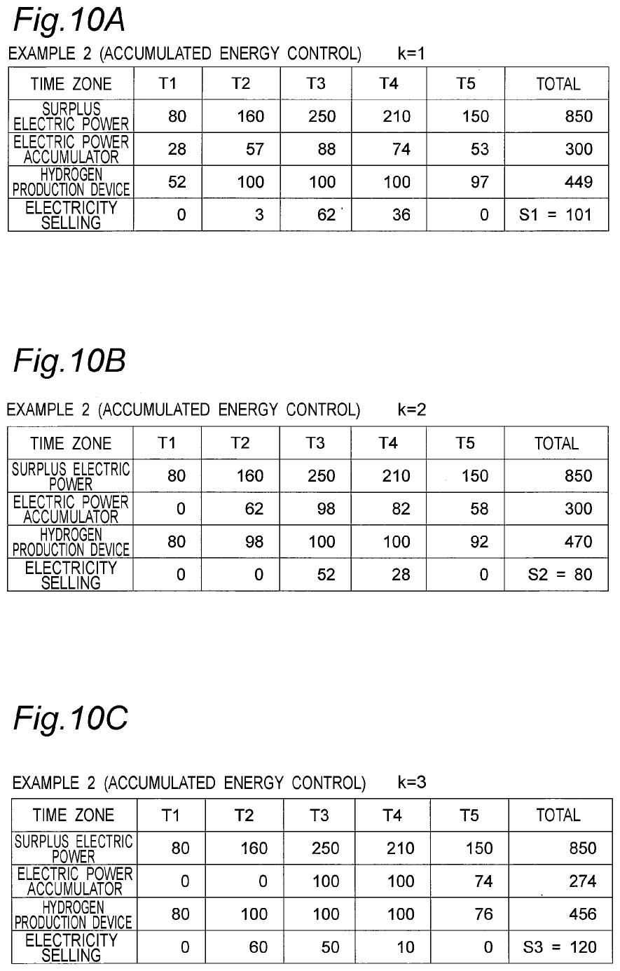

An accumulated energy control according to the second embodiment will be described with reference to a flowchart shown in FIG. 9 and a surplus electric power model according to Example 2 shown in FIGS. 10A, 10B, and 10C. The control described below is executed by the control device 80 included in the energy network 110.

At step S21 of FIG. 9, a time zone Tₖ to start supply of surplus electric power to the electric power accumulator 20 is set. Time zones subjected to accumulated energy control by the control device 80 are time zones T₁ to Tₙ (n is a natural number), and the time zone Tₖ (k is a value set in the range of 1 to n) is any time zone of the time zones T₁ to Tₙ to be controlled. At step S21, k=1 is initially set. The surplus electric power model of this Example 2 exemplifies the case of n=5 i.e. the case where the time zones to be controlled are T₁ to T₅.

Next, at step S1, the ratio of surplus electric power supply to the electric power accumulator 20 and the hydrogen-type power storage device 90 is set to 100% for the electric power accumulator 20 and 0% for the hydrogen-type power storage device 90 in the time zones Tₖ to Tₙ i.e. all the time zones T₁ to T₅.

Afterward, processes at steps S2 to S8 (see the first embodiment) are carried out. A surplus electric power model (case of k=1) as a result of carrying out these processes is shown in FIG. 10A. At step S4, power amount 550 exceeding power amount 300 storable in the electric power accumulator 20, relative to total value 850 of the predicted values of the surplus electric power amount, is allocated to the hydrogen-type power storage device 90. At this time, a uniform supply ratio is used in the time zones Tₖ to Tₙ i.e. all the time zones T₁ to T₅. Specifically, in the time zones T₁ to T₅, the ratio between the supply amount of surplus electric power to the electric power accumulator 20 and the supply amount to the hydrogen-type power storage device 90 is set to 35.3:64.7. The power amount exceeding the power amount chargeable into the hydrogen-type power storage device 90 is allocated to the electricity selling. As shown in FIG. 10A, power supply to the electricity selling occurs in the time zones T₂, T₃, and T₄.

It is then judged at step S22 whether total electricity selling amount Sₖ is 0 in the time zones T₁ to Tₙ i.e. all the time zones T₁ to T₅. As shown in FIG. 10A, total electricity selling amount S₁ (k=1) is 101, allowing shift to step S23. If the total electricity selling amount Sₖ is 0 in the time zones T₁ to Tₙ, procedure goes to step S9 at which the surplus electric power supply ratio is determined.

Next, at step S23, the total electricity selling amounts are compared to judge whether total electricity selling amount Sₖ₋₁<total electricity selling amount Sₖ is established. Due to k=1, the case of k−1 is not present, and therefore the above relational expression is judged not to be satisfied, allowing shift to step S24.

Next, at step S24, k=k+1 i.e. k=2 is set. Afterward, at step S25, the surplus electric power supply ratio is set to 0% for the electric power accumulator 20 and 100% for the hydrogen-type power storage device 90 in the time zones T₁ to Tₖ₋₁ i.e. the time zone T₁. In the time zones Tₖ to Tₙ i.e. time zones T₂ to T₅, the surplus electric power supply ratio is set to 100% for the electric power accumulator 20 and 0% for the hydrogen-type power storage device 90.

Afterward, processes at steps S2 to S8 are carried out. A surplus electric power model (case of k=2) as a result of carrying out these processes is shown in FIG. 10B. At step S4, in the time zones Tₖ to Tₙ i.e. time zones T₂ to T₅, power amount 470 exceeding power amount 300 storable in the electric power accumulator 20, relative to total value 770 of the predicted values of the surplus electric power amount, is allocated to the hydrogen-type power storage device 90. Specifically, in the time zones T₂ to T₅, the ratio between the supply amount of surplus electric power to the electric power accumulator 20 and the supply amount to the hydrogen-type power storage device 90 is set to 39.0:61.0. The power amount exceeding the power amount chargeable into the hydrogen-type power storage device 90 is allocated to the electricity selling. As shown in FIG. 10B, power supply to the electricity selling occurs in the time zones T₃ and T₄.

It is then judged at step S22 whether total electricity selling amount Sₖ is 0 in the time zones T₁ to Tₙ i.e. all the time zones T₁ to T₅. Since total electricity selling amount S₂ (k=2) is 80 as shown in FIG. 10B, procedure goes to step S23.

Next, at step S23, the total electricity selling amounts are compared to judge whether total electricity selling amount Sₖ₋₁<total electricity selling amount Sₖ is established. Total electricity selling amount S₁=101 and total electricity selling amount S₂=80 are compared with each other and the above relational expression is judged not to be established, allowing shift to step S24.

Next, at step S24, k=k+1 i.e. k=3 is set. Afterward, at step S25, the surplus electric power supply ratio is set to 0% for the electric power accumulator 20 and 100% for hydrogen-type power storage device 90 in the time zones T₁ to Tₖ₋₁ i.e. the time zones T₁ and T₂. In the time zones Tₖ to Tₙ i.e. time zones T₃ to T₅, the surplus electric power supply ratio is set to 100% for the electric power accumulator 20 and 0% for the hydrogen-type power storage device 90.

Afterward, processes at steps S2 to S8 are carried out. A surplus electric power model (case of k=3) as a result of carrying out these processes is shown in FIG. 10C. At step S4, in the time zones Tₖ to Tₙ i.e. time zones T₃ to T₅, power amount 310 exceeding power amount 300 storable in the electric power accumulator 20, relative to total value 610 of the predicted values of the surplus electric power amount, is allocated to the hydrogen-type power storage device 90. Specifically, in the time zones T₃ to T₅, the ratio between the supply amount of surplus electric power to the electric power accumulator 20 and the supply amount to the hydrogen-type power storage device 90 is set to 49.2:50.8. The power amount exceeding the power amount chargeable into the hydrogen-type power storage device 90 is allocated to the electricity selling. As shown in FIG. 10C, power supply to the electricity selling occurs in the time zones T₂, T₃, and T₄.

It is then judged at step S22 whether total electricity selling amount Sₖ is 0 in the time zones T₁ to Tₙ i.e. all the time zones T₁ to T₅. Since total electricity selling amount S₃ (k=3) is 120 as shown in FIG. 10C, procedure goes to step S23.

Next, at step S23, the total electricity selling amounts are compared to judge whether total electricity selling amount Sₖ₋₁<total electricity selling amount St is established. Total electricity selling amount S₂=80 and total electricity selling amount S₃=120 are compared with each other and the above relational expression is judged to be established, allowing shift to step S26.

At step S26, the surplus electric power supply ratio in the time zones T₁ to T₅ is determined as the supply ratio (FIG. 10B) in the case of k=k−1 i.e. the case of k=2 by the power supply ratio control unit 82. Based on the determined surplus electric power supply ratio, the equipment control unit 84 controls the supply of surplus electric power to the electric power accumulator 20, the hydrogen-type power storage device 90, and the electricity selling. In this Example 2, the surplus electric power supply ratio is determined as in the surplus electric power model of FIG. 10B and accumulated energy control is performed at the determined supply ratio.

### <Released Energy Control>

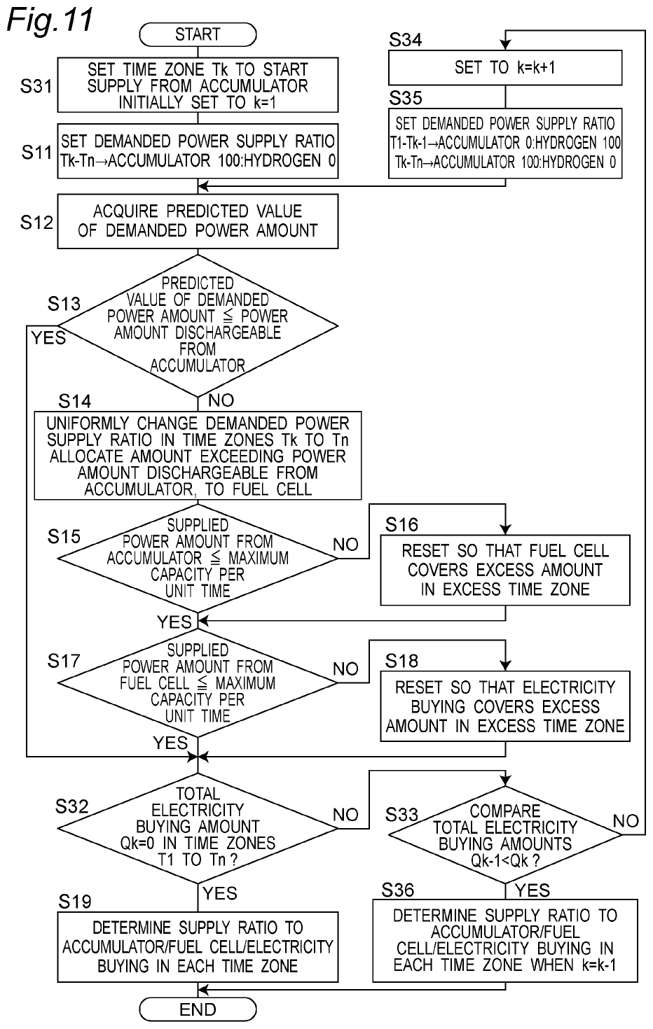

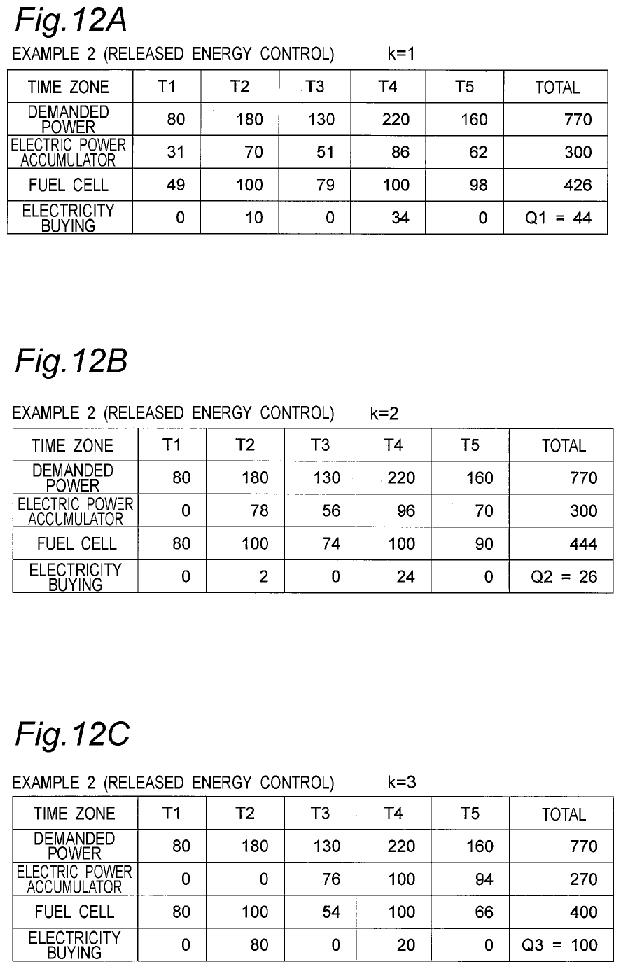

A released energy control according to the second embodiment will be described with reference to a flowchart shown in FIG. 11 and a surplus electric power model according to Example 2 shown in FIGS. 12A, 12B, and 12C. The control described below is executed by the control device 80 included in the energy network 110.

At step S31 of FIG. 11, a time zone Tₖ to start power supply from the electric power accumulator 20 to the demanded power is set. Time zones subjected to released energy control by the control device 80 are time zones T₁ to Tₙ (n is a natural number), and the time zone Tₖ (k is a value set in the range of 1 to n) is any time zone of the time zones T₁ to Tₙ to be controlled. At step S31, k=1 is initially set. The demanded power model of this Example 2 exemplifies the case of n=5 i.e. the case where the time zones to be controlled are T₁ to T₅.

Next, at step S11, the supply ratio from the electric power accumulator 20 and the hydrogen-type power storage device 90 to the demanded power is set to 100% for the electric power accumulator 20 and 0% for the hydrogen-type power storage device 90 in the time zones Tₖ to Ta i.e. all the time zones T₁ to T₅.

Afterward, processes at steps S12 to S18 (see the first embodiment) are carried out. A demanded power model (case of k=1) as a result of carrying out these processes is shown in FIG. 12A. At step S14, power amount 470 exceeding power amount 300 dischargeable from the electric power accumulator 20, relative to total value 770 of the predicted values of the demanded power amount, is allocated to the fuel cell system 50. At this time, a uniform supply ratio is used in the time zones Tₖ to Tₙ i.e. all the time zones T₁ to T₅. Specifically, in the time zones T₁ to T₅, the ratio between the distributed power amount from the electric power accumulator 20 to the demanded power and the distributed power amount from the fuel cell system 50 is set to 39.0:61.0. The supply ratio is reset so that the power amount exceeding the power amount dischargeable from the fuel cell system 50 is covered by the electricity buying. As shown in FIG. 12A, power supply from the electricity buying occurs in the time zones T₂ and T₄.

It is then judged at step S32 whether total electricity buying amount Qₖ is in the time zones T₁ to Tₙ i.e. all the time zones T₁ to T₅. As shown in FIG. 12A, total electricity buying amount Q₁ (k=1) is 44, allowing shift to step S33. If the total electricity buying amount Qₖ is 0 in the time zones T₁ to Tₙ, procedure goes to step S19 at which the supply ratio to the demanded power is determined.

Next, at step S33, the total electricity buying amounts are compared to judge whether total electricity buying amount Qₖ₋₁<total electricity buying amount Qₖ is established. Due to k=1, the case of k−1 is not present, and therefore the above relational expression is judged not to be satisfied, allowing shift to step S34.

Next, at step S34, k=k+1 i.e. k=2 is set. Afterward, at step S35, the power supply ratio to the demand is set to 0% for the electric power accumulator 20 and 100% for the hydrogen-type power storage device 90 in the time zones T₁ to Tₖ₋₁ i.e. the time zone T₁. In the time zones Tₖ to Tₙ i.e. time zones T₂ to T₅, the power supply ratio to the demanded power is set to 100% for the electric power accumulator 20 and 0% for the hydrogen-type power storage device 90.

Afterward, processes at steps S12 to S18 are carried out. A demanded power model (case of k=2) as a result of carrying out these processes is shown in FIG. 12B. At step S14, in the time zones Tₖ to Tₙ i.e. time zones T₂ to T₅, power amount 390 exceeding power amount 300 dischargeable from the electric power accumulator 20, relative to total value 680 of the predicted values of the demanded power amount, is allocated to the fuel cell system 50. Specifically, in the time zones T₂ to T₅, the ratio between the distributed power amount from the electric power accumulator 20 to the demanded power and the distributed power amount from the fuel cell system 50 is set to 43.5:66.5. The supply ratio is reset so that the power amount exceeding the power amount dischargeable from the fuel cell system 50 is covered by the electricity buying. As shown in FIG. 126, power supply from the electricity buying occurs in the time zones T₂ and T₄.

It is then judged at step S32 whether total electricity buying amount Qₖ is 0 in the time zones T₁ to Tₙ i.e. all the time zones T₁ to T₅. Since total electricity buying amount Q₂ (k=2) is 26 as shown in FIG. 12B, procedure goes to step S33.

Next, at step S33, the total electricity buying amounts are compared to judge whether total electricity buying amount Qₖ₋₁<total electricity buying amount Qₖ is established. Total electricity buying amount Q₁=44 and total electricity buying amount Q₂=26 are compared with each other and the above relational expression is judged not to be established, allowing shift to step S34.

Next, at step S34, k=k+1 i.e. k=3 is set. Afterward, at step S35, the power supply ratio to the demand is set to 0% for the electric power accumulator 20 and 100% for hydrogen-type power storage device 90 in the time zones T₁ to Tₖ₋₁ i.e. the time zones T₁ and T₂. In the time zones Tₖ to Tₙ i.e. time zones T₃ to T₅, the power supply ratio to the demanded power is set to 100% for the electric power accumulator 20 and 0% for the hydrogen-type power storage device 90.

Afterward, processes at steps S12 to S18 are carried out. A demanded power model (case of k=3) as a result of carrying out these processes is shown in FIG. 12C. At step S14, in the time zones Tₖ to Tₙ i.e. time zones T₃ to T₅, power amount 210 exceeding power amount 300 dischargeable from the electric power accumulator 20, relative to total value 510 of the predicted values of the demanded power amount, is allocated to the fuel cell system 50. Specifically, in the time zones T₃ to T₅, the ratio between the distributed power amount from the electric power accumulator 20 to the demanded power and the distributed power amount from the fuel cell system 50 is set to 58.8:41.2. The supply ratio is reset so that the power amount exceeding the power amount dischargeable from the fuel cell system 50 is covered by the electricity buying. As shown in FIG. 12C, power supply from the electricity buying occurs in the time zones T₂ and T₄.

It is then judged at step S32 whether total electricity buying amount Qₖ is 0 in the time zones T₁ to Tₙ i.e. all the time zones T₁ to T₅. Since total electricity selling amount Q₃ (k=3) is 100 as shown in FIG. 12C, procedure goes to step S33.

Next, at step S33, the total electricity buying amounts are compared to judge whether total electricity buying amount Qₖ₋₁<total electricity selling amount Qₖ is established. Total electricity buying amount Q₂=26 and total electricity buying amount Q₃=100 are compared with each other and the above relational expression is judged to be established, allowing shift to step S36.

At step S36, the surplus electric power supply ratio in the time zones T₁ to T₅ is determined as the supply ratio (FIG. 12B) in the case of k=k−1 i.e. the case of k=2 by the power distribution ratio control unit 83. Based on the determined power supply ratio to the demanded power, the equipment control unit 84 controls the power supply from the electric power accumulator 20, hydrogen-type power storage device 90, and the electricity buying. In this Example 2, the power supply ratio to the demanded power is determined as in the demanded power model of FIG. 12B and released energy control is performed at the determined supply ratio.

According to the second embodiment, it is possible in the accumulated energy control to reduce the surplus electric power supplied to the electricity selling, decrease the energy accumulation loss, and improve the surplus energy accumulation efficiency. It is possible in the released energy control to reduce the power supplied from the electricity buying to the demanded power, decrease the accumulated energy use loss, and enhance the accumulated energy use efficiency.

### OTHER EXAMPLES

Some Examples other than Examples described in the first and second embodiments will next be described. In the following description, the same reference numerals, step numbers, etc. are imparted to substantially the same constituent elements as those in the electric power supply system of the first embodiment, and explanations thereof will be omitted. Hereinafter, differences from the first embodiment will mainly be described.

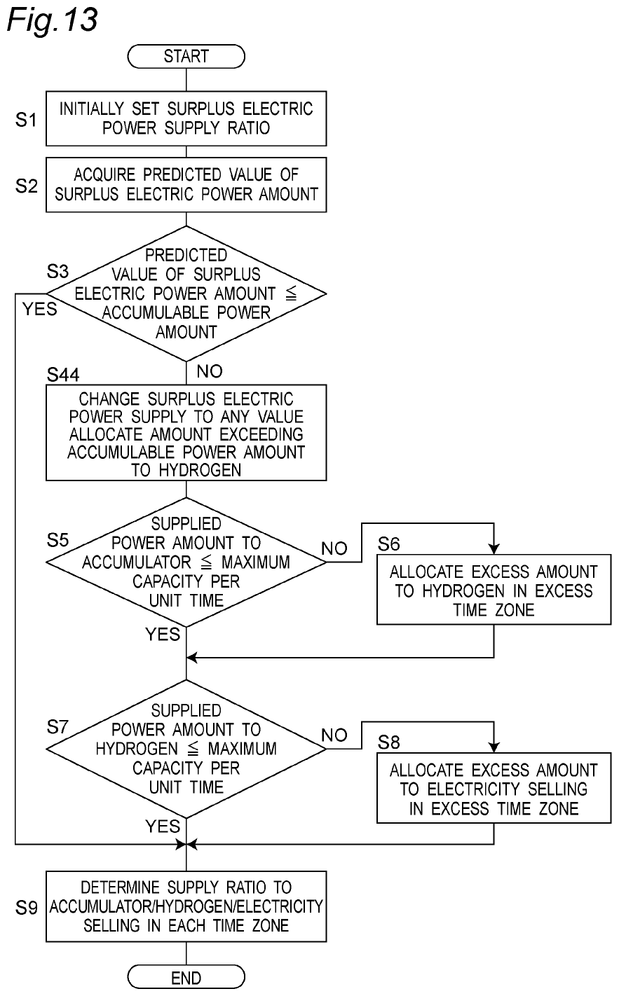

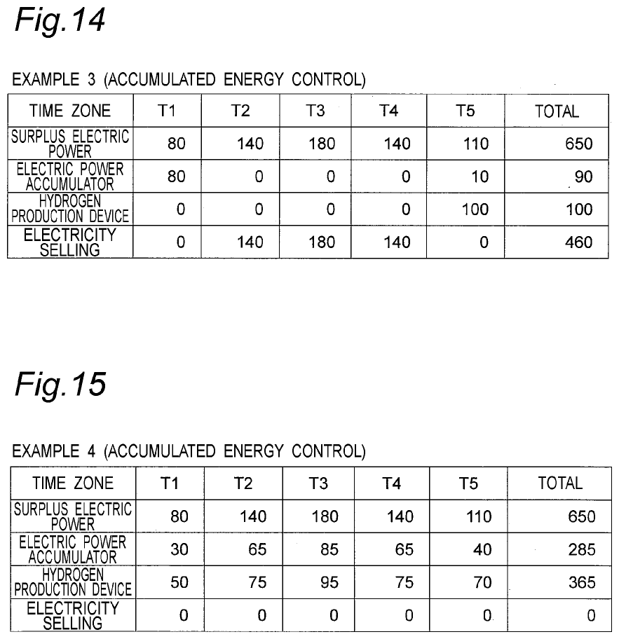

An accumulated energy control according to Examples 3 and 4 will first be described with reference to a flowchart shown in FIG. 13, a surplus electric power model of Example 3 shown in FIG. 14, and a surplus electric power model of Example 4 shown in FIG. 15. The control described below is executed by the control device 80 including the supplied power information acquisition unit 80a, the power supply ratio control unit 82, and the equipment control unit 84.

A difference of the flowchart of FIG. 13 from the accumulated energy control of the first embodiment described above lies in a process at step S44. Although step S4 of FIG. 4 includes performing the process of uniformly changing the surplus electric power supply ratio, at step S44 of FIG. 13 the surplus electric power supply is changed to any value. The other steps of FIG. 13 include performing the same processes as those of the corresponding steps in the flowchart of FIG. 4.

First, processes of steps S1 to S3 of FIG. 13 are performed for the surplus electric power model shown in FIG. 5A, similarly to Example 1. It is judged whether the total value of the predicted values of the surplus electric power amounts from the time zone T₁ up to the time zone T₅ is equal to or less than the power amount (total power amount) storable in the electric power accumulator 20 (step S3). Total value 650 of the predicted values of the surplus electric power amount from the time zone T₁ up to the time zone T₅ is judged as exceeding power amount 300 storable in the electric power accumulator 20.

Next, at step S44, the power supply ratio control unit 82 changes the surplus electric power supply to any value so that the amount exceeding the power amount storable in the electric power accumulator 20, relative to the total value of the predicted values of the surplus electric power amount from the time zone T₁ up to the time zone T₅, is allocated to the hydrogen-type power storage device 90.

The process of changing the surplus electric power supply to any value may be performed based on various pieces of information such as each equipment information, energy unit price information, or control setting information. For example, in Example 3 of FIG. 14, it is judged based on the energy unit price information that supplying electric power to the electricity selling has a higher cost merit in the time zones T₂ to T₄, allowing power allocation to the electricity selling. Based on the equipment information, electric power is preferentially distributed to the hydrogen-type power storage device 90 in the time zone T₅, and the power amount judged as exceeding the power amount storable per unit time is supplied to the electric power accumulator 20.

As shown in Example 4 of FIG. 15, the power distribution to the hydrogen-type power storage device 90 may take priority over the power distribution to the electric power accumulator 20. The ratio of such priority distribution may be constant regardless of the time zone or may be changed depending on the time zone.

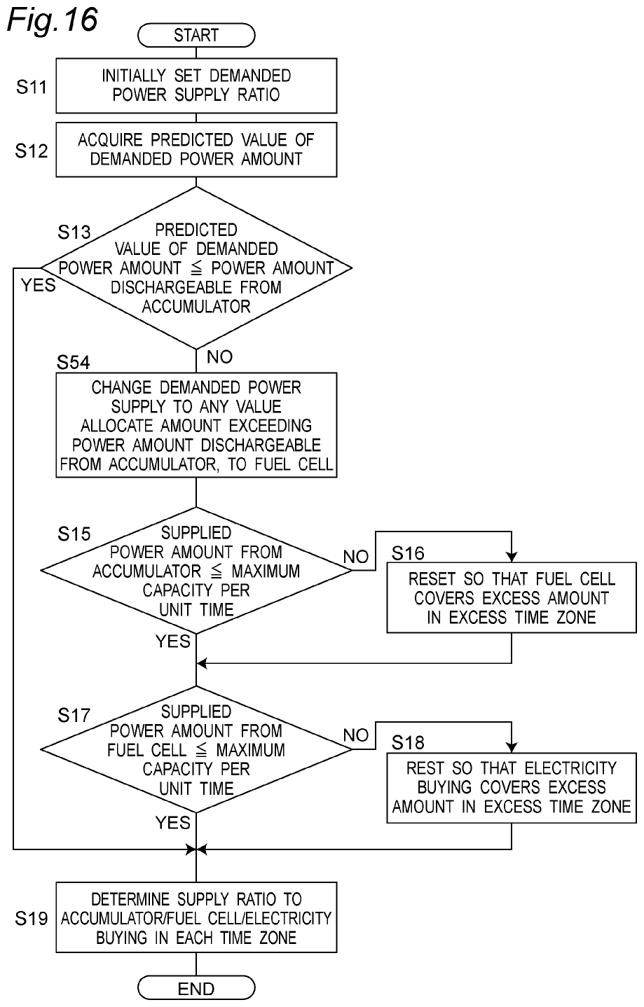

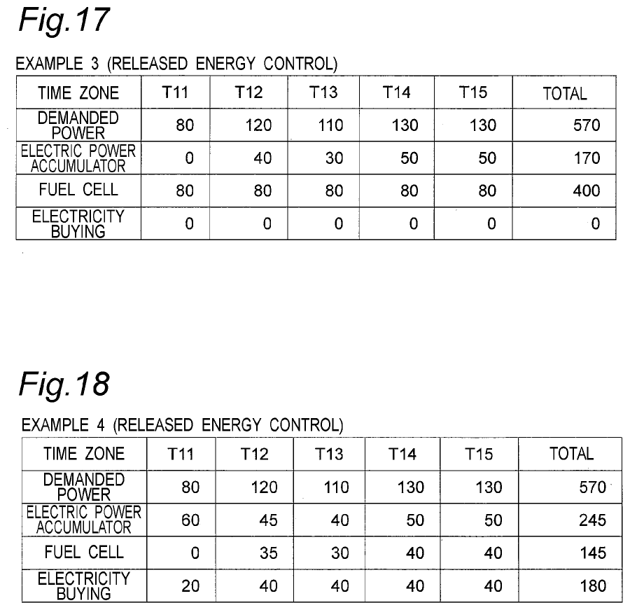

A released energy control according to Examples 3 and 4 will next be described with reference to a flowchart shown in FIG. 16, a demanded power model of Example 3 shown in FIG. 17, and a demanded power model of Example 4 shown in FIG. 18. The control described below is executed by the control device 80 including the distributed power information acquisition unit 80b, the power distribution ratio control unit 83, and the equipment control unit 84.

A difference of the flowchart of FIG. 16 from the released energy control of the first embodiment described above lies in a process at step S54. Although step S4 of FIG. 7 includes performing the process of uniformly changing the demanded power supply ratio, at step S54 of FIG. 16 the demanded power supply is changed to any value. The other steps of FIG. 16 include performing the same processes as those of the corresponding steps in the flowchart of FIG. 7.

First, processes of steps S11 to S13 of FIG. 16 are performed for the demanded power model shown in FIG. 8A, similarly to Example 1. It is judged whether the total value of the predicted values of the demanded power amount from the time zone T₁₁ up to the time zone T₁₅ is equal to or less than the power amount (total power amount) dischargeable from the electric power accumulator 20 (step S13). Total value 570 of the predicted values of the surplus electric power amount from the time zone T₁₁ up to the time zone T₁₅ is judged as exceeding power amount 300 dischargeable from the electric power accumulator 20.

Next, at step S54, the power supply to the demanded power is changed to any value by the power distribution ratio control unit 83 so that the amount exceeding the power amount dischargeable from the electric power accumulator 20, relative to the total value of the predicted values of the demanded power amount from the time zone T₁₁ up to the time zone T₁₅, is allocated to the hydrogen-type power storage device 90 i.e. the fuel cell system 50.

The process of changing the power supply to any value may be performed based on various pieces of information such as each equipment information, energy unit price information, and control setting information. For example, in Example 3 of FIG. 17, it is set to use the fuel cell system 50 as a base load. The ratio between the distributed power amount from the electric power accumulator 20 and the distributed power amount from the fuel cell system 50 is set based on this setting information.

As shown in Example 4 of FIG. 18, in an emergency, electric power may be distributed from the electricity buying to the demanded power so that the demanded power can be met by at least one of the electric power accumulator 20 or the fuel cell system 50. The ratio of power distribution from the electricity buying may be constant regardless of the time zone or may be changed depending on the time zone.

Although the above description of the embodiment exemplifies the case where both the accumulated energy control and the released energy control are executed together in the electric power supply system, the present disclosure is not limited to such a case. For example, in the electric power supply system, only the accumulated energy control may be executed or only the released energy control may be executed.

In the above embodiments, the method (first embodiment) of uniformly changing the supply ratio between the electric power accumulator 20 and the hydrogen-type power storage device 90 in all the time zones has been described. In this description, the method (second embodiment) of dividing the time zones into time zones exclusively using the hydrogen-type power storage device 90 and time zones in which the supply ratio between the electric power accumulator and the hydrogen-type power storage device is uniformly changed has been described. However, the electric power supply system according to the present disclosure is not limited to these, and the supply ratio may be changed based on chargeable/dischargeable power amount per unit time of the electric power accumulator and the hydrogen-type power storage device that depends on the time zone. For example, if the user sets a predetermined remaining amount of accumulated power of the electric power accumulator at a specific time (e.g. keeping 50% remaining amount of accumulated power at the point of the time zone T₃), the supply ratio up to the specific time (e.g. up to the time zone T₃) may differ from the subsequent supply ratio.

In the case e.g. where an electric power accumulator and a hydrogen-type power storage device are disposed inside a moving body such an automobile so that electric power is used for travelling of the automobile in addition to power supply to the load, the supply ratio in a predetermined time duration may be changed based on the travelling schedule (for example, due to a schedule to go out with an electric vehicle in the time zones T₃ and T₄, the charge/discharge allocation of the electric power accumulator for this duration is set to 0%).

As regards “supply ratio”, the above embodiments have exemplified the case where respective supply ratio values of the electric power accumulator and the hydrogen-type power storage device are set with surplus electric power/demanded power in each time zone being 100%. In lieu of such a case, respective supply ratio values may be set with the total value of “chargeable/dischargeable power amount per unit time” of the electric power accumulator and that of the hydrogen-type power storage device being 100% in advance.

By properly combining any ones of the above various embodiments, the respective effects can be achieved.

Although the present invention has been fully described in relation to the preferred embodiment while referring to the accompanying drawings, it is apparent for those skilled in the art to be able to make various variations and modifications. Such variations and modifications should be construed as being included therein without departing from the scope of the present invention defined by the appended claims.

The electric power supply system of the present disclosure is useful as an electric power supply system accumulating and using surplus electric power of the natural-energy power generator.

### EXPLANATIONS OF LETTERS OR NUMERALS

10 natural-energy power generator
20 electric power accumulator
30 hydrogen production device
40 hydrogen storage device
50 fuel cell system
60 load unit
61 power consumer
70 electric power line
80 control device
80a supplied power information acquisition unit
80b distributed power information acquisition unit
81 electricity rate information acquisition unit
82 power supply ratio control unit
83 power distribution ratio control unit
84 equipment control unit
90 hydrogen-type power storage device
100 storage system
110 energy network

1. An electric power supply system comprising:
a hydrogen production device producing hydrogen using electric power supplied from a natural-energy power generator;
a hydrogen storage device storing hydrogen produced by the hydrogen production device;
a fuel cell system generating electricity using hydrogen stored in the hydrogen storage device, to supply the generated electric power to a load;
an electric power accumulator accumulating electric power supplied from the natural-energy power generator, to supply the accumulated power to the load; and
a control device configured to control supply of electric power to and/or from the fuel cell system and the electric power accumulator,
wherein the control device executes;
i) a first control for supplying electric power to the load from each of the electric power accumulator and the fuel cell system in a time zone in which demanded power of the load is smaller than electric power dischargeable from the electric power accumulator, and/or
ii) a first power charge control for supplying the surplus electric power to each of the electric power accumulator and the hydrogen production device in a time zone in which the surplus electric power of the natural-energy power generator is smaller than electric power chargeable into the electric power accumulator.

2. The electric power supply system according to claim 1, wherein the control device executes a second power discharge control for rendering electric power supplied from the electric power accumulator to the load smaller than electric power dischargeable from the electric power accumulator in a time zone in which demanded power of the load is larger than electric power dischargeable from the electric power accumulator.

3. The electric power supply system according to claim 1, wherein the control device executes the first power discharge control when demanded power amount that is integrated demanded power value of the load in a predetermined period of time is larger than power amount dischargeable from the electric power accumulator.

4. The electric power supply system according to claim 2, wherein the control device executes the first power discharge control and the second power discharge control when demanded power amount that is integrated value of demanded power of the load in a predetermined period of time is larger than power amount dischargeable from the electric power accumulator.

5. A method of controlling an electric power supply system, the electric power supply system supplying electric power to and/or from an electric power line, a natural-energy power generator, an electric power accumulator, and a fuel cell system, the method comprising:
producing hydrogen by a hydrogen production device using surplus electric power of the natural-energy power generator;
storing the produced hydrogen in a hydrogen storage device;
generating electricity by the fuel cell system using the stored hydrogen, to supply electric power to a load;
charging the electric power accumulator with surplus electric power of the natural-energy power generator;
discharging electricity from the electric power accumulator, to supply electric power to the load; and
executing;
i) a first power discharge control for supplying electric power to the load from each of the electric power accumulator and the fuel cell system in a time zone in which demanded power of the load is smaller than electric power dischargeable from the electric power accumulator, and/or
ii) a first power charge control for supplying the surplus electric power of the natural-energy power generator to each of the electric power accumulator and the hydrogen production device in a time zone in which the surplus electric power is smaller than electric power chargeable into the electric power accumulator.

6. The method of controlling an electric power supply system according to claim 5, further comprising:
executing a second power discharge control for rendering electric power supplied from the electric power accumulator to the load smaller than electric power dischargeable from the electric power accumulator in a time zone in which demanded power of the load is larger than electric power dischargeable from the electric power accumulator.

7. A control device of an electric power supply system, the electric power supply system supplying electric power to a load from an electric power line, a natural-energy power generator, an electric power accumulator charged with surplus electric power of the natural-energy power generator, and a fuel cell system generating electricity using hydrogen generated with surplus electric power of the natural-energy power generator, the control device comprising:
a power distribution ratio control unit configured to set a power distribution ratio of electric power so that electric power is supplied to the load from each of the electric power accumulator and the fuel cell system in a time zone in which demanded power of the load is smaller than electric power dischargeable from the electric power accumulator; and
an equipment control unit configured to provide control to supply electric power from the electric power accumulator and the fuel cell system to the load, based on the power distribution ratio set by the power distribution ratio control unit.

8. The control device of an electric power supply system according to claim 7, wherein the power distribution ratio control unit sets the power distribution ratio of electric power so that electric power supplied from the electric power accumulator to the load becomes smaller than electric power dischargeable from the electric power accumulator in a time zone in which demanded power of the load is larger than electric power dischargeable from the electric power accumulator.

9. The control device of an electric power supply system according to claim 7, wherein the power distribution ratio control unit sets the power distribution ratio of electric power so that electric power is supplied from each of the electric power accumulator and the fuel cell system to the load when demanded power amount that is integrated demanded power value of the load in a predetermined period of time is larger than power amount dischargeable from the electric power accumulator.

10. The control device of an electric power supply system according to claim 8, wherein the power distribution ratio control unit sets the power distribution ratio of electric power so that, when demanded power amount that is integrated demanded power value of the load in a predetermined period of time is larger than power amount dischargeable from the electric power accumulator, electric power is supplied from each of the electric power accumulator and the fuel cell system to the load so that electric power supplied from the electric power accumulator to the load becomes smaller than electric power dischargeable from the electric power accumulator.

11. (canceled)

12. The electric power supply system according to claim 1, wherein the control device executes a second power charge control for rendering the surplus electric power supplied to the electric power accumulator smaller than electric power chargeable into the electric power accumulator in a time zone in which the surplus electric power of the natural-energy power generator is larger than electric power chargeable into the electric power accumulator.

13. The electric power supply system according to claim 11, wherein the control device executes the first power charge control when surplus electric power amount that is integrated surplus electric power value of the natural-energy power generator in a predetermined period of time is larger than power amount chargeable into the electric power accumulator.

14. The electric power supply system according to claim 12, wherein the control device executes the first power charge control and the second power charge control when surplus electric power amount that is integrated surplus electric power value of the natural-energy power generator in a predetermined period of time is larger than power amount chargeable into the electric power accumulator.

15. (canceled)

16. The method of controlling an electric power supply system according to claim 5, further comprising:
executing a second power charge control for rendering the surplus electric power of the natural-energy power generator supplied to the electric power accumulator smaller than electric power chargeable into the electric power accumulator in a time zone in which the surplus electric power is larger than electric power chargeable into the electric power accumulator.

17. (canceled)

18. (canceled)

19. (canceled)

20. (canceled)
